(19) United States
(12) Patent Application Publication
(10) Pub. No.: US 2011/0123918 A1
(43) Pub. Date: May 26, 2011

(54) COLORING MATERIAL AND METHOD FOR PRODUCING COLORING MATERIAL

(75) Inventor: Motonari Udo, Shizuoka-ken (JP)

(73) Assignee: TOSHIBA TEC KABUSHIKI KAISHA, Tokyo (JP)

(21) Appl. No.: 12/874,579

(22) Filed: Sep. 2, 2010

Related U.S. Application Data
(60) Provisional application No. 61/263,485, filed on Nov. 23, 2009.

(51) Int. Cl. G03G 9/09

(52) U.S. Cl. 430/108.2; 430/108.1; 430/108.21; 430/137.21

(57) ABSTRACT

According to one embodiment, a color erasable coloring material containing a binder resin, and dispersed therein, a color developable compound and a color developing agent is provided. The color developing agent to be used in the coloring material contains at least an aminohydroxy derivative. The aminohydroxy derivative is obtained by subjecting a starting material selected from a benzene ring compound having a hydroxy group and a heterocyclic compound having a hydroxy group to nitration, hydrogenation, and alkylation.

### CROSS-REFERENCE TO RELATED APPLICATIONS

This application is based upon and claims the benefit of priority from U.S. Provisional Application No. 61/263,485, filed on Nov. 23, 2009; the entire contents of which are incorporated herein by reference.

### FIELD

Embodiments described herein relate generally to an erasable coloring material which can be applied to an electrophotographic developer, an inkjet ink, etc.

### BACKGROUND

A technique for recycling a recording medium such as paper by, for example, erasing the color of a toner or ink image formed on the recording medium such as paper is very effective from the viewpoint of environmental protection and economic efficiency due to reduction in the using amount of a recording medium such as paper.

Like an electrophotographic toner containing a color developable compound proposed by Toshiba, etc., a toner having a color erasing property is known. The technique is such that a color developable compound and a color developing agent are incorporated in the inside of a toner by a so-called kneading pulverization method. If a phenol compound which does not have an amino group is used as the color developing agent, in order to develop a color, the phenol compound in a molar amount 2.5 times or more as much as that of the color developable compound is required. The color development and erasure are improved as the amount of the color developing agent increases. However, if the color developing agent in a 2.5 or more times molar amount is required, 5 wt % or more of the color developing agent is required in a toner, which results in decreasing the content of a binder resin, and therefore, the fixing property tends to deteriorate. Further, if the amount of the color developing agent is less than 5 wt %, sufficient color development cannot be obtained. Therefore, a toner which has an excellent fixing property, can achieve sufficient color development, and has a color erasing property could not be obtained.

### BRIEF DESCRIPTION OF THE DRAWINGS

FIG. 1 is a graph showing a relationship between a proportion of a color developing agent in a coloring material according to an embodiment and a powder density.

FIG. 2 is a graph showing a relationship between a proportion of a color developing agent in a coloring material according to an embodiment and an erasing ratio.

FIG. 3 is a schematic view showing a structure of an image forming apparatus to which a coloring material according to an embodiment can be applied as a developer.

### DETAILED DESCRIPTION

In general, according to one embodiment, a color erasable coloring material containing a binder resin, and dispersed therein, a color developable compound and a color developing agent is provided.

The color developing agent to be used in the coloring material contains at least an aminohydroxy derivative.

The aminohydroxy derivative is obtained by subjecting a starting material selected from a benzene ring compound having a hydroxy group and a heterocyclic compound having a hydroxy group to nitration, hydrogenation, and alkylation.

In the color erasable coloring material according to an embodiment, the color developable compound turns into a color developed state by the interaction of the color developable compound with the color developing agent, both of which are dispersed in the binder resin.

Further, a method for producing a color erasable coloring material according to an embodiment includes: preparing an aminohydroxy derivative by subjecting a starting material selected from a benzene ring compound having a hydroxy group and a heterocyclic compound having a hydroxy group to nitration, hydrogenation, and alkylation; and mixing a color developing agent containing, as at least a part thereof, the aminohydroxy derivative, a color developable compound, and a binder resin.

According to this embodiment, a coloring material having excellent fixing property, can achieve sufficient color development, and has a color erasing property can be obtained.

By pulverizing such a coloring material into fine particles, the coloring material can be used as, for example, an electrophotographic developer. By using such a developer, a clear image can be formed on a recording medium such as paper or a transparent resin sheet.

Further, the coloring material according to this embodiment can be erased (the color thereof can be erased) by heating. The erasure of the color of the coloring material is caused by a mechanism that the color developable compound and the color developing agent which interact with each other in the binder resin no longer interact with each other by heating. The color developing agent moves to, for example, paper which is a recording medium when the color is erased by heating. The color developing agent after moving forms a hydrogen bond with a hydroxy group of cellulose constituting the paper, and therefore, the coloring material turns into a color erased state.

The color erasable coloring material has a tendency that it has a higher developed color density as the content of a polar group in the binder resin in which the color developable compound and the color developing agent are dispersed is lower. In order to obtain a high color developing property and a high contrast of color erasure, a non-polar resin can be used as the binder resin, and as such a non-polar resin, for example, polystyrene, a polystyrene derivative, a styrene copolymer, and the like can be used. A polar electron donating group contained in the binder resin acts on an interacting body of the color developable compound and the color developing agent and contributes to the dissociation of the interacting body of these compounds. Further, the polar electron donating group has a function to capture the color developing agent by interacting with the color developing agent, and therefore, the proportion of the color developing agent capable of interacting with the color developable compound in the coloring material can decrease. Therefore, it is possible to increase the developed color density of the coloring material by using a binder resin having relatively few polar electron donating groups.

On the other hand, when a polyester resin is tried to be used as the binder resin for fixing the toner at a low temperature, the developed color density tends to decrease because the polyester resin contains a lot of polar electron donating groups. By only replacing a portion of the non-polar resin by a polyester resin, the developed color density decreases to a large extent.

However, it was found that when, as the color developing agent, an aminohydroxy derivative having an amino group and a hydroxy group, for example, secondary amino bisphenol A is used and the blending ratio of the secondary amino bisphenol A to the coloring material is 1.2 wt % or more and 2 wt % or less, even if a polyester resin is used in the binder resin, not only the developed color density can be maintained, but also a favorable color erasing property and an excellent fixing property can be maintained.

### (Color Developable Compound)

In this embodiment, a leuco dye is used as the color developable compound. The leuco dye is an organic pigment whose color tone changes reversibly due to oxidation and reduction, and examples thereof include triphenylmethane, fluoran, and azaphthalide compounds having a lactone ring. Examples of the triphenylmethane leuco dye include crystal violet lactone (CVL). As the fluoran leuco dye, there are, for example, a black leuco dye represented by the form of 2-anilino-6-(N-alkyl-N-alkylamino)-3-methylfluoran and a derivative thereof. Specific examples thereof include 2-anilino-6-(N,N-diethylamino)-3-methylfluoran, 2-anilino-6-(N,N-dipropylamino)-3-methylfluoran, 2-anilino-6-(N,N-dibutylamino)-3-methylfluoran, 2-anilino-6-(N,N-dipentylamino)-3-methylfluoran, 2-anilino-6-(N,N-dihexylamino)-3-methylfluoran, 2-anilino-6-(N,N-dioctylamino)-3-methylfluoran, 2-anilino-6-(N,N-diisopropylamino)-3-methylfluoran, 2-anilino-6-(N,N-diisobutylamino)-3-methylfluoran, 2-anilino-6-(N,N-diisopentylamino)-3-methylfluoran, 2-anilino-6-(N-methyl-N-ethylamino)-3-methylfluoran, 2-anilino-6-(N-methyl-N-isopropylamino)-3-methylfluoran, 2-anilino-6-(N-methyl-N-isobutylamino)-3-methylfluoran, 2-anilino-6-(N-methyl-N-isopentylamino)-3-methylfluoran, 2-anilino-6-(N-methyl-N-propylamino)-3-methylfluoran, 2-anilino-6-(N-methyl-N-butylamino)-3-methylfluoran, 2-anilino-6-(N-methyl-N-pentylamino)-3-methylfluoran, 2-anilino-6-(N-methyl-N-hexylamino)-3-methylfluoran, 2-anilino-6-(N-methyl-N-octylamino)-3-methylfluoran, 2-anilino-6-(N-ethyl-N-propylamino)-3-methylfluoran, 2-anilino-6-(N-ethyl-N-isobutylamino)-3-methylfluoran, 2-anilino-6-(N-ethyl-N-pentylamino)-3-methylfluoran, 2-anilino-6-(N-ethyl-N-2-methylbutylamino)-3-methylfluoran, 2-anilino-6-(N-ethyl-N-2-ethylpropylamino)-3-methylfluoran, and 2-anilino-6-(N-ethyl-N-hexylamino)-3-methylfluoran.

By mixing two or more leuco dyes including crystal violet lactone and a fluoran compound represented by the form of 2-anilino-6-(N-alkyl-N-alkylamino)-3-methylfluoran, a coloring material which achieves excellent color development and erasure can be obtained.

### (Color Developing Agent)

The color developing agent which can be used in this embodiment is a substance which interacts with the above-mentioned color developable compound to cause the color developable compound to develop a color.

As the color developing agent, an aminohydroxy derivative which can be formed by using a compound having a hydroxy group on a ring such as a benzene ring, a heterocyclic ring, or cycloalkene as a starting material through at least nitration, hydrogenation, and alkylation steps can be used.

The benzene ring compound can be selected from the group consisting of benzene, naphthalene, and anthracene.

The heterocyclic compound can be selected from the group consisting of pyridine, pyrimidine, furan, and thiophene.

Examples of the aminohydroxy derivative which can be used in this embodiment include organic compounds having a hydroxy group and an amino group such as aminophenols, metal salts of aminophenols, compounds having a hydroxy group and an amino group in a heterocyclic ring, and metal salts of compounds having a hydroxy group and an amino group in a heterocyclic ring.

As an example of the aminohydroxy derivative, a compound represented by the following formula (1) can be exemplified.

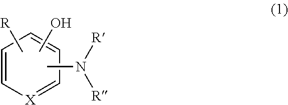

The aminohydroxy derivative represented by the formula (1) has a structure in which one of the hydrogen atoms in a benzene ring or a fused polycyclic skeleton is replaced by an amino group and a hydroxy group.

In the formula (1), R, R′, and R″ are selected from hydrogen, alkyl, alkene, a benzene ring, a heterocyclic ring, cycloalkane, and cycloalkene.

Here, aminohydroxy derivative can have an amino group at least at the ortho position relative to a hydroxy group on the benzene ring.

Further, a benzene ring compound in which an amino group is located at the ortho and meta positions relative to a hydroxy group or a benzene ring compound in which an amino group is located at the ortho and para positions relative to a hydroxy group can be used.

In this embodiment, as the color developing agent, specifically, for example, N-methyl aminopyrogallol, N-ethyl aminopyrogallol, N-octadecyl aminopyrogallol, N-methyl aminobisphenol A, N-ethyl aminobisphenol A, N-octadecyl aminobisphenol A, or the like can be used.

Further, another color developing agent may be contained as long as the amount thereof is 10% or less of the amount of the color developing agent to be used in the coloring material. The weight ratio of, for example, N-ethyl aminopyrogallol to the coloring material is 1 wt % or more and 3 wt % or less.

Further, the aminohydroxy derivative may contain an amino group having a nitrogen atom and an alkyl group which is adjacent to the nitrogen atom and has 1 to 30 carbon atoms.

The aminohydroxy derivative may be contained in an amount of from 0.5 to 5 wt % of the total amount of the coloring material.

### (Binder Resin)

The binder resin is a component for dispersing the color developable compound and the color developing agent therein when the coloring material is prepared.

On the other hand, the binder resin preferably has a characteristic of allowing the color developing agent to move to a recording material when the color is erased by heating. In this embodiment, a binder resin containing a non-polar styrene-based resin and a polyester resin can be used.

Examples of the non-polar styrene-based resin include polystyrene, a polystyrene derivative, and a styrene copolymer. Specific examples of a styrene-based monomer constituting the polystyrene, polystyrene derivative, and styrene copolymer include styrene, α-methylstyrene, o-methylstyrene, m-methylstyrene, p-methylstyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, p-phenylstyrene, p-chlorostyrene, and 3,4-dichlorostyrene. In particular, when a resin obtained by alloying a polymer of a styrene-butadiene copolymer with an α-methylstyrene-styrene copolymer oligomer is used, a coloring material having excellent color developing and erasing properties can be obtained.

Further, examples of the polyester resin include polyethylene terephthalate resins, polyethylene isophthalate resins, polypropylene terephthalate resins, and polypropylene isophthalate resins.

In this embodiment, it was found that if N-methyl aminopyrogallol is used as the color developing agent when the amount of the non-polar styrene-based resin and the polyester resin is 30 wt % or more and 70 wt % or less in the binder resin, the developed color density can be maintained. If the amount thereof is less than 30 wt %, the fixing at a low temperature becomes difficult, and if the amount thereof exceeds 70%, there is a tendency that the coloring material may not sufficiently develop a color. Further, the thermal properties of a resin for use in the toner are generally represented by values of a softening point and a glass transition point. In a normal toner, a resin having a softening point of from 60 to 190° C. and a glass transition point of from 20 to 110° C. is used. However, when the coloring material according to this embodiment is used, preferred thermal properties of the binder resin can be set as follows: the softening point is from 90 to 150° C. and the glass transition point is from 55 to 85° C. If the softening point and the glass transition point are higher than the above-mentioned temperature, the fixing temperature of the toner is high, and there is a tendency that the color is erased when the toner is fixed. If the softening point and the glass transition point are low, there is a tendency that the storage stability of the toner deteriorates. The softening point can be measured using a flow tester or the like, and the glass transition point can be measured using a DSC (differential scanning calorimeter) or the like. Here, the softening point is a temperature (T1/2) when the flow-out amount of a sample reaches the half value of the sample amount using a flow tester (CFT-500 manufactured by Shimadzu Corporation) under the conditions that the nozzle size is 1.0 mm φ×10.0 mm, the load is 30 kg·f, the temperature rising rate is 3° C./min, and the sample amount is 1.0 g. The glass transition point is a temperature calculated as a shoulder value after melt-quenching using a DSC. The shoulder value is an inflection point of a specific heat change and is referred to as “an intermediate point between a start point and an end point” in the vicinity of a point where a specific heat changes.

The color developable compound and the color developing agent can be blended in the binder resin at a molar ratio of 1:0.5 to 10 (color developable compound:color developing agent). If the ratio of the color developing agent to the color developable compound is less than 0.5, a sufficient interaction cannot be obtained and the color developing performance tends to be poor. If the two materials are blended at a ratio thereof exceeding 10, the material which does not contribute to the color development increases and goes to waste, and also the physical properties such as a fixing property may sometimes be adversely affected. The binder resin serves as a matrix constituting the coloring material, and the ratio thereof varies depending on the content of the below-mentioned additives and the like. For example, when the coloring material is used in a developer, the binder resin can be generally used in an amount of 80 wt % or more and 95 wt % or less with respect to the toner. If the amount thereof is less than 80 wt %, image leakage occurs, etc., and the fixing performance of the toner tends to be affected. If the amount thereof exceeds 95 wt %, the ratio of the color developable compound and the color developing agent to the coloring material decreases, and the color developing performance tends to be affected.

When the coloring material according to this embodiment is applied to the toner, a variety of additive components as used in a normal toner can be contained other than the color developable compound, color developing agent, and binder resin.

A variety of materials to be added other than the color developable compound, color developing agent, and binder resin will be described.

First, in order to adjust the charge characteristic of the toner, a charge control agent may be added. As for the charge control agent, it is preferred that the color of the charge control agent is not left behind when the color is erased. Therefore, the charge control agent is preferably colorless or transparent. Among commonly used charge control agents, as a negatively charged material, E-89 (a calixarene derivative) manufactured by Orient Chemical Co., Ltd., N-1, N-2, and N-3 (all are phenolic compounds) manufactured by Japan Carlit Co., Ltd., LR-147 (a boron compound) manufactured by Japan Carlit Co., Ltd., FCA-1001N (a styrene-sulfonic acid resin) manufactured by Fujikura Kasei Co., Ltd. or the like can be used. As a more preferred compound, E-89 or LR-147 can be exemplified. Examples of a positively charged material include TP-302 (CAS#116810-46-9) and TP-415 (CAS#117342-25-2) manufactured by Hodogaya Chemical Co., Ltd., P-51 (a quaternary amine compound) and AFP-B (a polyamine oligomer) manufactured by Orient Chemical Co., Ltd., and FCA-2012B (a styrene-acrylic quaternary ammonium salt resin) manufactured by Fujikura Kasei Co., Ltd. Further, in order to control the fixing property, a wax or the like may be blended.

The wax to be used in the coloring material according to this embodiment is preferably composed of a component which does not cause the color developable compound to develop a color. For example, a higher alcohol, a higher ketone, a higher aliphatic ester, or the like is preferably used. If it is defined by an acid value, 10 mg KOH/g or less is preferred. Further, it is more preferred to use a wax having a weight average molecular weight of from 10² to 10⁵, preferably from 10² to 10⁴. A low molecular weight polypropylene, a low molecular weight polyethylene, a low molecular weight polybutylene, a low molecular weight polyalkane, or the like can also be used as long as the weight average molecular weight thereof is in this range. The addition amount of such a wax is preferably from 0.1 to 30 parts by weight, more preferably from 0.5 to 15 parts by weight. Incidentally, in the case of a toner which is fixed by a heat roll, the wax is added for imparting a property of releasing from the heat roll, and therefore, the addition amount of the wax is preferably 5 parts by weight or less, and in the case of a toner which is fixed by applying pressure, the wax can be used as a main component of the coloring material, and constitutes a core portion when the toner has a microcapsule structure. Further, a plasticizer may be blended for improving the erasing performance. The erasure of the color of the coloring material is caused by binding the color developing agent to a hydroxy group in paper, and the diffusion movement of the color developing agent in the medium affects the color erasing performance thereof.

If the binder resin is moderately plasticized by adding a plasticizer, the inhibition of the movement of the color developing agent due to a dispersion force, a dipole-dipole force, a hydrogen bond, or the like is reduced, and therefore, the erasing performance is further improved. Examples of the plasticizer to be added to the coloring material include phthalic acid derivatives, adipic acid derivatives, azelaic acid derivatives, cebacic acid derivatives, maleic acid derivatives, fumaric acid derivatives, trimellitic acid derivatives, citric acid derivatives, oleic acid derivatives, ricinoleic acid derivatives, stearic acid derivatives, sulfonic acid derivatives, phosphoric acid derivatives, glycerin derivatives, paraffin derivatives, and diphenyl derivatives. Specific examples thereof include di(2-ethylhexyl)phthalate, dimethyl phthalate, diethyl phthalate, dibutyl phthalate, diisobutyl phthalate, diheptyl phthalate, diisooctyl phthalate, octyldecyl phthalate, diisodecyl phthalate, ditridecyl phthalate, ethylhexyldecyl phthalate, dinonyl phthalate, butylbenzyl phthalate, dicyclohexyl phthalate, diallyl phthalate, dimethoxyethyl phthalate, dibutoxyethyl phthalate, methylphthalylethyl glycol, ethylphthalylethyl glycolate, butylphthalylbutyl glycolate, di-n-butyl adipate, diisobutyl adipate, di(2-ethylhexyl)adipate, diisooctyl adipate, diisodecyl adipate, octyldecyl adipate, benzyl-n-butyl adipate, polypropylene adipate, polybutylene adipate, dibutoxyethyl adipate, benzyloctyl adipate, di(2-ethylhexyl)azelate, di-2-ethylhexyl-4-thioazelate, di-n-hexyl azelate, diiosbutyl azelate, dimethyl cebacate, diethyl cebacate, dibutyl cebacate, di(2-ethylhexyl)cebacate, diiosoctyl cebacate, di-n-butyl maleate, dimethyl maleate, diethyl maleate, di-(2-ethylhexyl)maleate, dinoyl maleate, dibutyl fumarate, di(2-ethylhexyl)fumarate, tri-(2-ethylhexyl)trimellitate, triisodecyl trimellitate, n-octyl trimellitate, n-decyl trimellitate, triisooctyl trimellitate, diisooctyl trimellitate, monoisodecyl trimellitate, triethyl citrate, tri-n-butyl citrate, methyl oleate, butyl oleate, methoxyethyl oleate, tetrahydrofulfuryl oleate, glyceryl monooleate, diethyleneglycol monooleate, methylacetyl ricinoleate, butylacetyl ricinoleate, glyceryl monoricinoleate, diethyleneglycol monoricinoleate, n-butyl stearate, glyceryl monostearate, chlorinated methyl stearate, benzenesulfone butylamide, o-toluene sulfonamide, p-toluene sulfonamide, N-ethyl-p-toluene sulfonamide, o-tolueneethyl sulfonamide, p-tolueneethyl sulfonamide, N-cyclohexyl-p-toluene sulfonamide, triethyl phosphate, tributyl phosphate, tri(2-ethylhexyl)phosphate, triphenyl phosphate, tris(chloroethyl)phosphate, polyethylene glycol, chlorinated paraffin, and chlorinated diphenyl. The optimal addition amount of the plasticizer subtly varies depending on the type of surfactant, however, a proper amount thereof is about 0.5 wt % or less. In order to obtain a particularly high effect, a phthalic acid derivative, a trimellitic acid derivative, or the like having a benzene ring or an alicyclic structure may be added.

In the coloring material of this embodiment, an external additive or the like for controlling fluidity, storage stability, anti-blocking property, polishability for a photoconductor, or the like can be further blended as needed. As the external additive, silica fine particles, metal oxide fine particles, a cleaning aid, or the like can be used. Examples of the silica fine particles include fine particles of silicon dioxide, sodium silicate, zinc silicate, and magnesium silicate. Examples of the metal oxide fine particles include fine particles of zinc oxide, magnesium oxide, zirconium oxide, strontium titanate, and barium titanate. Examples of the cleaning aid include resin fine powder of polymethyl methacrylate, polyvinylidene fluoride, and polytetrafluoroethylene. These external additives may be subjected to a surface treatment such as a hydrophobizing treatment. The hydrophobizing treatment is usually performed when the additive is used for the toner, and in the case of a negatively charged additive, a treatment agent such as a silane coupling agent, a titanium coupling agent, or silicone oil is used. Further, in the case of a positively charged additive, a treatment agent such as an aminosilane-based agent or silicone oil having an amine at the side chain is used. The addition amount of the external additive is preferably from 0.05 to 5 parts by weight, more preferably from 0.1 to 3.0 parts by weight with respect to 100 parts by weight of the toner. As for the average particle diameter of the primary particles to be used for the toner, in the case of silica fine particles, the particles having an average particle diameter of from 10 to 20 nm are generally used, and in addition to these, particles having an average particle diameter up to 100 nm are also used. In the case of a material other than silica, the particle diameter is increased, and particles having an average particle diameter of from 0.05 to 3 μm are generally used. A preferred range of the particle diameter of the toner is as follows: the volume average diameter is from 6 to 20 μm; the content of the particles having a diameter of 5 μm or less in the number distribution is from 2 to 20% by particles; the content of the particles having a diameter of 5 μm or less in the volume distribution is from 0 to 5% by volume; and the content of the particles having a diameter of 20 μm or more in the volume distribution is from 0 to 5% by volume.

These are measured using a Coulter Multisizer (manufactured by Coulter Co., Ltd.). The conductivity of the color erasable toner is preferably from 10¹¹ to 10¹⁶Ω·cm, more preferably form 10¹³ to 10¹⁵Ω·cm.

In the case of two-component development, a carrier prepared by coating iron powder, ferrite, magnetite, or the like with a resin such as a silicone resin or acrylic resin is used. The range of the conductivity of the carrier is as follows: 10⁹Ω·cm or less in the case of iron powder; from about 10⁶ to 10¹⁵Ω·cm in the case of ferrite; 10¹³Ω·cm or more in the case of magnetite; and 10¹³Ω·cm or more in the case of a carrier prepared by dispersing magnetic powder pulverized to a size of about 50 μm in a resin.

The conductivity is measured by forming the toner into a disk-shaped tablet with a diameter of 20 mm and a thickness of 1 mm, followed by applying an electric potential of 1 V and 1 kHz.

The color erasable coloring material is prepared by mixing and dispersing the above-mentioned color developable compound, color developing agent, binder resin, and the like. As the method for mixing and dispersing the color developable compound and color developing agent in the binder resin, a wet dispersion method using a solvent (in the case of containing a color erasing agent, a non-polar solvent) with a device such as a high-speed dissolver, a roll mill, or a ball mill; a melt kneading method using a roll, a pressure kneader, an internal mixer, a screw extruder, a biaxial roll, or a triple roll; or the like can be used. Further, as a mixing unit, a ball mill, a V-type mixer, a Forberg mixer, a Henschel mixer, or the like can be used.

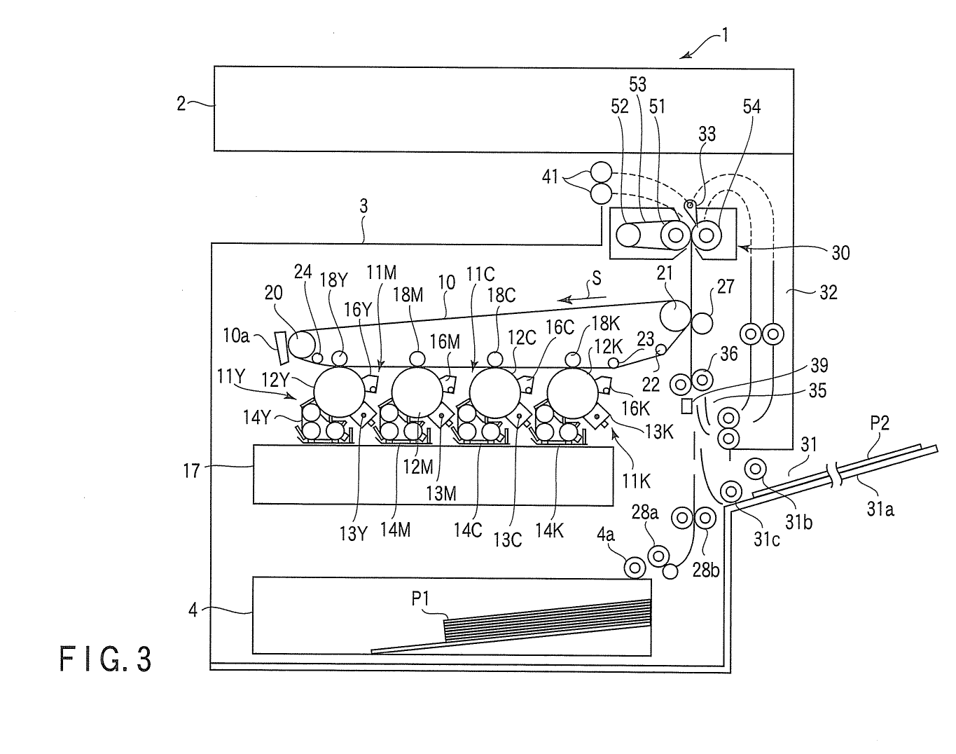

FIG. 3 is a schematic view showing a structure of a copier to which a developer prepared by using a coloring material according to an embodiment can be applied.

As shown in the drawing, a four-drum tandem type color copier MFP (e-studio 4520c) 1 is provided with a scanner unit 2 and a paper discharge unit 3 in the upper part.

The color copier 1 has four sets of image forming stations 11Y, 11M, 11C, and 11K of yellow (Y), magenta (M), cyan (C), and black (K) arranged in parallel along the lower side of an intermediate transfer belt (intermediate transfer medium) 10.

The image forming stations 11Y, 11M, 11C, and 11K have photoconductive drums (image carrying members) 12Y, 12M, 12C, and 12K, respectively. Around the photoconductive drums 12Y, 12M, 12C, and 12K, electric chargers 13Y, 13M, 13C, and 13K, developing devices 14Y, 14M, 14C, and 14K, and photoconductor cleaning devices 16Y, 16M, 16C, and 16K are provided along the rotational direction of the arrow m, respectively. An exposure light from a laser exposure device (latent image forming device) 17 is applied to areas between the respective electric chargers 13Y, 13M, 13C, and 13K and the respective developing devices 14Y, 14M, 14C, and 14K around the photoconductive drums 12Y, 12M, 12C, and 12K, and electrostatic latent images are formed on the photoconductive drums 12Y, 12M, 12C, and 12K, respectively.

The developing devices 14Y, 14M, 14C, and 14K each have a two-component developer containing a toner of yellow (Y), magenta (M), cyan (C), or black (K) and a carrier and supply the toner to the electrostatic latent images on the photoconductive drums 12Y, 12M, 12C, and 12K, respectively.

The intermediate transfer belt 10 is tensioned by a backup roller 21, a driven roller 20, and first to third tension rollers 22 to 24. The intermediate transfer belt 10 faces and is in contact with the photoconductive drums 12Y, 12M, 12C, and 12K. At the positions of the intermediate transfer belt 10 facing the photoconductive drums 12Y, 12M, 12C, and 12K, primary transfer rollers 18Y, 18M, 18C, and 18K for primarily transferring toner images on the photoconductive drums 12Y, 12M, 12C, and 12K onto the intermediate transfer belt 10 are provided. The primary transfer rollers 18Y, 18M, 18C, and 18K are each a conductive roller, and apply a primary transfer bias voltage to the respective primary transfer parts.

In a secondary transfer part as a transfer position supported by the backup roller 21 of the intermediate transfer belt 10, a secondary transfer roller 27 is provided. In the secondary transfer part, the backup roller 21 is a conductive roller and a predetermined secondary transfer bias is applied thereto. When a sheet of paper (final transfer medium) which is a print target passes between the intermediate transfer belt 10 and the secondary transfer roller 27, the toner image on the intermediate transfer belt 10 is secondarily transferred onto the sheet of paper. After completion of the secondary transfer, the intermediate transfer belt 10 is cleaned by a belt cleaner 10a.

A paper feed cassette 4 for feeding a sheet of paper in the direction toward the secondary transfer roller 27 is provided below the laser exposure device 17. On the right side of the color copier 1, a manual feed mechanism 31 for manually feeding a sheet of paper is provided.

A pickup roller 4a, a separating roller 28a, a conveying roller 28b, and a resist roller pair 36 are provided between the paper feed cassette 4 and the secondary transfer roller 27, and these are constituent members of a paper feed mechanism. A manual feed pickup roller 31b and a manual feed separating roller 31c are provided between a manual feed tray 31a of the manual feed mechanism 31 and the resist roller pair 36.

Further, a medium sensor 39 for detecting the type of a sheet of paper is disposed on a vertical conveying path 34 for conveying a sheet of paper in the direction from the paper feed cassette 4 or the manual feed tray 31a to the secondary transfer roller 27. In the color copier 1, the conveying speed of a sheet of paper, a transfer condition, a fixing condition, and the like can be controlled according to the detection result of the medium sensor 39. Further, a fixing device 30 is provided in the downstream of the secondary transfer part along the direction of the vertical conveying path 34.

The sheet of paper taken out from the paper feed cassette 4 or fed from the manual feed mechanism 31 is conveyed to the fixing device 30 along the vertical conveying path 34 through the resist roller pair 36 and the secondary transfer roller 27. The fixing device 30 has a set of a heating roller 51 and a driving roller 52, a fixing belt 53 wound around the heating roller 51 and the driving roller 52, and a facing roller 54 disposed to face the heating roller 51 via the fixing belt 53. The sheet of paper having the toner image transferred in the secondary transfer part is guided between the fixing belt 53 and the facing roller 54 and heated by the heating roller 51, whereby the toner image transferred onto the sheet of paper is fixed through a heat treatment. A gate 33 is provided in the downstream of the fixing device 30, and distributes the sheet of paper in the direction toward a paper discharge roller 41 or the direction toward a re-conveying unit 32. The sheet of paper guided to the paper discharge roller 41 is discharged to the paper discharge unit 3. Further, the sheet of paper guided to the re-conveying unit 32 is again guided in the direction toward the secondary transfer roller 27.

The image forming station 11Y integrally includes the photoconductive drum 12Y and a process system, and is provided such that it is attachable to and detachable from the image forming apparatus main body. The process system refers to at least one of the electric charger 13Y, the developing device 14Y, and the photoconductor cleaning device 16Y. The image forming stations 11M, 11C, and 11K each have the same structure as the image forming station 11Y, and each of the image forming stations 11Y, 11M, 11C, and 11K may be separately attachable to and detachable from the image forming apparatus, or they may be integrally attachable to and detachable from the image forming apparatus as an integral image forming unit 11.

Hereinafter, embodiments will be more specifically described with reference to Examples.

Incidentally, the particle diameter is measured using SALD-7000 manufactured by Shimadzu Corporation, and GC-MS and NMR are performed using GC-2010 manufactured by Shimadzu Corporation, and Lambda 300 manufactured by JEOL Ltd., respectively.

### Example 1

In Examples, various aminophenol compounds were prepared as a color developing agent.

### Preparation of Pyrogallol Derivative

### Preparation of Color Developing Agent (Nitration)

Methylene chloride: 60 g

Pyrogallol: 30 g

Concentrated nitric acid (concentration: 60%, density: 1.38 g/cm³): 10 g

After methylene chloride and pyrogallol were mixed in a three-neck flask, a thermometer, a cooling tube, and a dropping funnel were connected thereto. Then, the mixture was cooled to 0° C. while moderately stirring, and concentrated nitric acid was added dropwise thereto through the dropping funnel such that the temperature of the content was 5° C. or lower. After 30 minutes from the completion of the dropwise addition, an aqueous solution of sodium bicarbonate was slowly added thereto. After completion of neutralization, an oil layer was obtained with a separating funnel. While moderately stirring the oil layer, 1-hexane was added thereto to obtain a precipitate. The precipitate was sufficiently dried, whereby a nitrated intermediate was obtained. By performing GC-MS, H¹-NMR, and C¹³-NMR, it was found that a 98% nitrated pyrogallol compound was obtained.

### Preparation of Color Developing Agent (Hydrogenation)

N,N-dimethylformamide (DMF): 79 g

Nitrated pyrogallol compound: 20 g

5% Palladium catalyst: 1 g

DMF, the nitrated pyrogallol compound, and a magnetic stirrer were put in a 200 cc stainless steel autoclave, and further a 5% palladium catalyst was added thereto. Then, the mixture was moderately stirred and sufficiently subjected to nitrogen replacement, followed by hydrogen replacement, and then, 99.9% hydrogen was slowly filled into the autoclave to a pressure of 0.3 MPa. The mixture was heated to 80° C. in an oil bath, and pressurization was continued so as to maintain a constant pressure of 0.3 MPa. The pressurization was stopped when hydrogen was no longer consumed, and the resulting mixture was cooled to room temperature, and then sufficiently subjected to nitrogen replacement. Then, the content was taken out and distilled water was added thereto, whereby a precipitate was obtained. Then, the precipitate was sufficiently washed and dried. By performing gas chromatography mass spectrometry (GC-MS), H¹-NMR, and C¹³-NMR, it was found that a 98% primary aminopyrogallol compound was obtained.

### Preparation of Color Developing Agent (Alkylation)

Methanol: 79 g

Primary aminopyrogallol compound: 20 g

5% nickel-copper mixed catalyst: 1 g

Methanol, the primary aminopyrogallol compound, and a magnetic stirrer were put in a 200 cc stainless steel autoclave, and further a 5% nickel-copper catalyst was added thereto. Then, the mixture was moderately stirred and sufficiently subjected to nitrogen replacement. Subsequently, the mixture was heated to 120° C. in an oil bath and maintained for 5 hours. The resulting mixture was cooled to room temperature, and the content was taken out and distilled water was added thereto, whereby a precipitate was obtained. Then, the precipitate was sufficiently dried. By performing GC-MS, H¹-NMR, and C¹³-NMR, it was found that, as a pyrogallol derivative, a 98% secondary aminopyrogallol compound was obtained.

The thus obtained secondary aminopyrogallol compound is represented by the following formula (2).

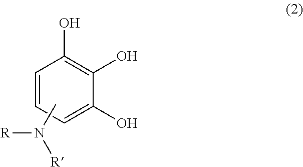

In the above formula (2), R represents hydrogen, alkyl, alkene, a benzene ring, a heterocyclic ring, cycloalkane, or cycloalkene; and R′ represents hydrogen, alkyl, alkene, a benzene ring, a heterocyclic ring, cycloalkane, or cycloalkene

In this pyrogallol derivative, the positions of one amino group relative to two hydroxy groups are the ortho and para positions.

### Preparation of Toner Particles

### Composition of Sample

Crystal violet lactone (CVL) represented by the following formula (3): 3.8 g

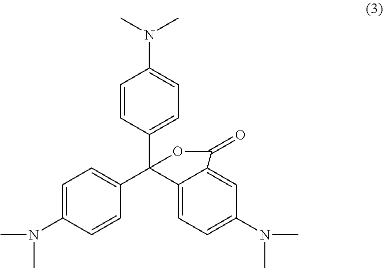

Leuco dye S205 (manufactured by Yamada Chemical Co., Ltd.): 0.5 g

Polypropylene wax: 1.0 g

Charge control agent LR-147 (manufactured by Japan Carlit Co., Ltd.): 1.0 g

Secondary aminopyrogallol: 2 g

Styrene-butadiene copolymer: 36.9 g

α-methylstyrene-styrene copolymer oligomer: 8.9 g

Polyester resin: 45.9 g

In the above sample, CVL (a leuco dye manufactured by Yamada Chemical Co., Ltd.) and 2-anilino-6-(N-ethyl-N-isopentylamino)-3-methylfluoran (a leuco dye S205, manufactured by Yamada Chemical Co., Ltd.) as color developable compounds, secondary aminopyrogallol as a color developing agent, polypropylene wax as a wax component, a charge control agent (LR-147, manufactured by Japan Carlit Co., Ltd.), and a blend of a styrene-butadiene copolymer having a weight ratio of butadiene of 10 wt %, an α-methylstyrene-styrene copolymer oligomer, and a polyester resin (XPE 2007, manufactured by Mitsui Chemicals, Inc.) at a weight ratio of 4:1:5 as a binder resin were used.

The respective materials were sufficiently mixed using a Henschel mixer, and the resulting mixture was kneaded and dispersed using a triple roll (at a temperature of 140° C.). Further, the kneaded material was processed into fine powder having an average particle diameter of 6.8±0.5 μm using a crusher, whereby a blue electrophotographic toner was obtained. This fine powder was measured for powder density using a colorimeter CR-300 manufactured by Minolta Co., Ltd. (using a powder measurement cell). This powder density is a value calculated as a common logarithm of the reciprocal of the reflectivity. As the proportion of the color developable compound in a color developed state is higher, a higher powder density is obtained.

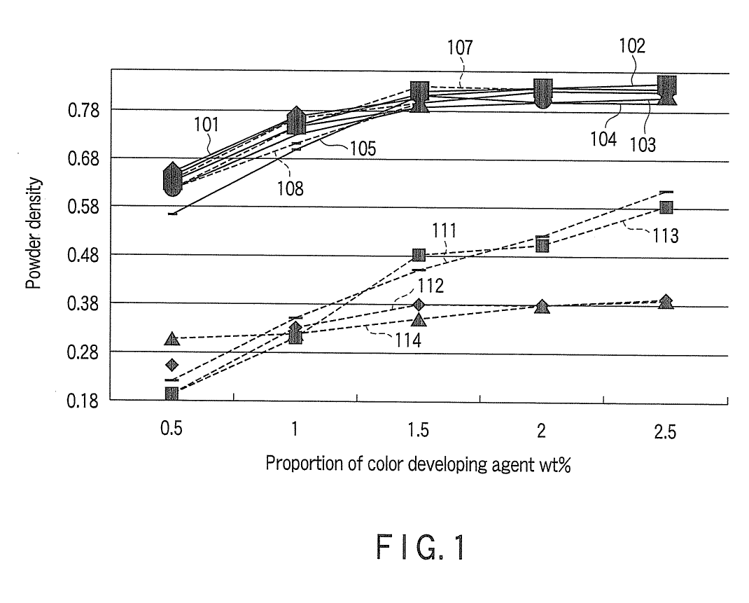

The measurement results of the powder density versus the proportion of the color developing agent are shown in FIG. 1 and Table 1.

Hydrophobic silica was externally added to the thus prepared toner in an amount of 1 wt % of the total amount of the toner. The resulting toner was used for printing a solid pattern with several stages of image ID on a sheet of copy paper using MFP (e-studio 351) manufactured by Toshiba Tec Corporation to prepare images for evaluating erasing performance. The image was erased by heating at 130° C. for 2 hours using a constant temperature chamber. The erasing performance was determined as follows. A slope of a regression line of data obtained by plotting a value of [(original image ID)−(paper ID)] before erasure by heating on the horizontal axis and plotting a value of [(residual image ID)−(paper ID)] after erasure by heating on the vertical axis was determined for each paper to be evaluated, and an arithmetic average thereof for several types of paper was adopted as an erasing ratio. This numerical value represents the proportion of the density of the residual image to that of the original image, and it is indicated that as the numerical value is smaller, the heat erasing performance is higher. For example, a heat erasing ratio of 0.05 indicates that the density of a residual image which remains after an image having an image density of 1.0 is erased by heating is 0.05.

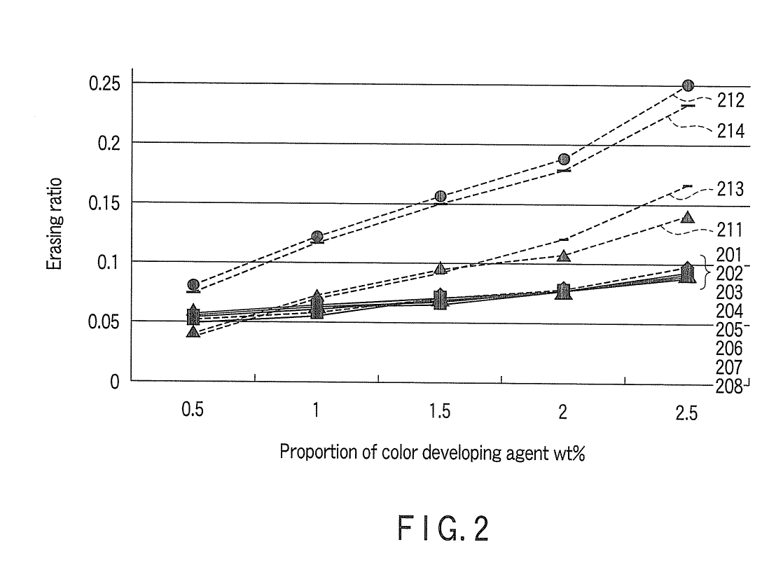

The erasing ratio versus the proportion of the color developing agent is shown in FIG. 2 and Table 2.

When the erasing ratio is 0.08 or less, the erasing performance is good.

Further, a patch pattern with several stages of image ID was printed on a sheet of copy paper and a color fastness to rubbing test was performed using a color fastness to rubbing tester RT-300 manufactured by Daiei Kagaku Seiki Mfg. Co., Ltd. The tester was set as follows: testing table shape: curved surface (radius: 200 mm), rubbing finger shape: curved surface (radius: 45 mm), testing load: 2 N, reciprocating rubbing distance: 120 mm, and reciprocating rubbing speed: 5 times. The performance of color fastness to rubbing was determined as follows. A slope of a regression line of data obtained by plotting a value of [(original image ID)−(paper ID)] before testing on the horizontal axis and plotting a value of [(residual image ID)−(paper ID)] after testing on the vertical axis was determined for each paper to be evaluated, and an arithmetic average thereof for several types of paper was adopted as a ratio of color fastness to rubbing. This numerical value represents the proportion of the density of the residual image to that of the original image, and it is indicated that as the numerical value is larger, the abrasion resistant performance is higher. For example, a ratio of color fastness to rubbing versus the proportion of the color developing agent of 0.8 indicates that the density of a residual image which remains after an image having an image density of 1.5 is rubbed is 1.2.

The ratio of color fastness to rubbing versus the proportion of the color developing agent is shown in Table 3.

When the ratio of color fastness to rubbing is 0.8 or more, the performance of color fastness to rubbing is good.

In the case of this formulation using 2% secondary aminopyrogallol, the powder density was 0.83 and therefore, the color development was determined to be good. Further, the erasing ratio was 0.079, and therefore, the color erasure was determined to be good.

The ratio of color fastness to rubbing was 0.89, and therefore the performance of color fastness to rubbing was determined to be good. Further, by a paper feed test in which 10000 sheets of paper were fed through MFP (e-studio 351) manufactured by Toshiba Tec Corporation, it was found that fixing can be performed without any problems.

### Example 2

### Preparation of Color Developing Agent (Nitration)

Methylene chloride: 60 g

Bisphenol A: 30 g

Concentrated nitric acid (concentration: 60%, density: 1.38 g/cm³): 10 g

After methylene chloride and bisphenol A were mixed in a three-neck flask, a thermometer, a cooling tube, and a dropping funnel were connected thereto. Then, the mixture was cooled to 0° C. while moderately stirring, and concentrated nitric acid was added dropwise thereto through the dropping funnel such that the temperature of the content was 5° C. or lower. After 30 minutes from the completion of the dropwise addition, an aqueous solution of sodium bicarbonate was slowly added thereto. After completion of neutralization, an oil layer was obtained with a separating funnel. While moderately stirring the oil layer, 1-hexane was added thereto to obtain a precipitate. The precipitate was sufficiently dried, whereby a nitrated intermediate was obtained. By performing GC-MS, H¹-NMR, and C¹³-NMR, it was found that a 98% nitrated bisphenol A compound was obtained.

### Preparation of Color Developing Agent (Hydrogenation)

DMF: 79 g

Nitrated bisphenol A: 20 g

5% Palladium catalyst: 1 g

DMF, the nitrated intermediate, and a magnetic stirrer were put in a 200 cc stainless steel autoclave, and further a 5% palladium catalyst was added thereto. Then, the mixture was moderately stirred and sufficiently subjected to nitrogen replacement, followed by hydrogen replacement, and then, 99.9% hydrogen was slowly filled into the autoclave to a pressure of 0.3 MPa. The mixture was heated to 80° C. in an oil bath, and pressurization was continued so as to maintain a constant pressure of 0.3 MPa. The pressurization was stopped when hydrogen was no longer consumed, and the resulting mixture was cooled to room temperature, and then sufficiently subjected to nitrogen replacement. Then, the content was taken out and distilled water was added thereto, whereby a precipitate was obtained. Then, the precipitate was sufficiently washed and dried. By performing GC-MS, H¹-NMR, and C¹³-NMR, it was found that a 98% primary aminobisphenol A compound was obtained.

### Preparation of Color Developing Agent (Alkylation)

Methanol: 79 g

Primary aminobisphenol A compound: 20 g

5% nickel mixed catalyst: 1 g

Methanol, the primary aminobisphenol A compound, and a magnetic stirrer were put in a 200 cc stainless steel autoclave, and further a 5% nickel mixed catalyst was added thereto. Then, the mixture was moderately stirred and sufficiently subjected to nitrogen replacement. Subsequently, the mixture was heated to 120° C. in an oil bath and maintained for 5 hours. The resulting mixture was cooled to room temperature, and the content was taken out and distilled water was added thereto, whereby a precipitate was obtained. Then, the precipitate was sufficiently dried. By performing GC-MS, H¹-NMR, and C¹³-NMR, it was found that, as a bisphenol A derivative, a 98% secondary aminobisphenol A compound was obtained.

The thus obtained secondary aminobisphenol A compound is represented by the following formula (4).

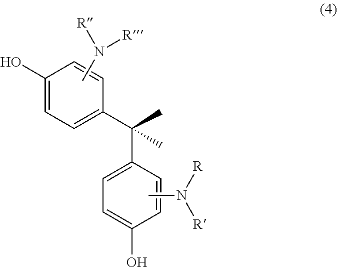

In the above formula (4), R represents hydrogen, alkyl, alkene, a benzene ring, a heterocyclic ring, cycloalkane, or cycloalkene; R′ represents hydrogen, alkyl, alkene, a benzene ring, a heterocyclic ring, cycloalkane, or cycloalkene; R″ represents hydrogen, alkyl, alkene, a benzene ring, a heterocyclic ring, cycloalkane, or cycloalkene; and R′″ represents hydrogen, alkyl, alkene, a benzene ring, a heterocyclic ring, cycloalkane, or cycloalkene.

The above formula (4) represents a derivative in which one amino group is located at the ortho position relative to one hydroxy group or a derivative in which an amino group is located at the ortho and meta positions.

### Preparation of Toner Particles

### Composition of Sample

CVL: 3.8 g

S205: 0.5 g

Polypropylene wax: 1.0 g

LR-147: 1.0 g

Secondary aminobisphenol A: 1.5 g

Styrene-butadiene copolymer: 36.9 g

α-methylstyrene-styrene copolymer oligomer: 8.9 g

Polyester resin: 45.9 g

In the above sample, CVL (a leuco dye manufactured by Yamada Chemical Co., Ltd.) and 2-anilino-6-(N-ethyl-N-isopentylamino)-3-methylfluoran (a leuco dye S205, manufactured by Yamada Chemical Co., Ltd.) as color developable compounds, secondary aminobisphenol A as a color developing agent, polypropylene wax as a wax component, a charge control agent (LR-147, manufactured by Japan Carlit Co., Ltd.), and a blend of a styrene-butadiene copolymer having a weight ratio of butadiene of 10 wt %, an α-methylstyrene-styrene copolymer oligomer, and a polyester resin (XPE 2007, manufactured by Mitsui Chemicals, Inc.) at a weight ratio of 4:1:5 as a binder resin were used.

The respective materials were sufficiently mixed using a Henschel mixer, and the resulting mixture was kneaded and dispersed using a triple roll (at a temperature of 140° C.). Further, the kneaded material was processed into fine powder having an average particle diameter of 6.8±0.5 μm using a crusher, whereby a blue electrophotographic toner was obtained. This fine powder was measured for powder density using a colorimeter CR-300 manufactured by Minolta Co., Ltd. (using a powder measurement cell). This powder density is a value calculated as a common logarithm of the reciprocal of the reflectivity. As the proportion of the color developable compound in a color developed state is higher, a higher powder density is obtained. The measurement results of the powder density are shown in FIG. 1 and Table 1.

Hydrophobic silica was externally added to the thus prepared toner in an amount of 1 wt % of the total amount of the toner. The resulting toner was used for printing a solid pattern with several stages of image ID on a sheet of copy paper using MFP (e-studio 351) manufactured by Toshiba Tec Corporation to prepare images for evaluating erasing performance. The image was erased by heating at 130° C. for 2 hours using a constant temperature chamber. The erasing performance was determined as follows. A slope of a regression line of data obtained by plotting a value of [(original image ID)−(paper ID)] before erasure by heating on the horizontal axis and plotting a value of [(residual image ID)−(paper ID)] after erasure by heating on the vertical axis was determined for each paper to be evaluated, and an arithmetic average thereof for several types of paper was adopted as an erasing ratio. This numerical value represents the proportion of the density of the residual image to that of the original image, and it is indicated that as the numerical value is smaller, the heat erasing performance is higher. For example, a heat erasing ratio of 0.05 indicates that the density of a residual image which remains after an image having an image density of 1.0 is erased by heating is 0.05. The erasing ratio versus the proportion of the color developing agent is shown in FIG. 2 and Table 2.

Further, a patch pattern with several stages of image ID was printed on a sheet of copy paper and a color fastness to rubbing test was performed using a color fastness to rubbing tester RT-300 manufactured by Daiei Kagaku Seiki Mfg. Co., Ltd. The tester was set as follows: testing table shape: curved surface (radius: 200 mm), rubbing finger shape: curved surface (radius: 45 mm), testing load: 2 N, reciprocating rubbing distance: 120 mm, and reciprocating rubbing speed: 5 times. The performance of color fastness to rubbing was determined as follows. A slope of a regression line of data obtained by plotting a value of [(original image ID)−(paper ID)] before testing on the horizontal axis and plotting a value of [(residual image ID)−(paper ID)] after testing on the vertical axis was determined for each paper to be evaluated, and an arithmetic average thereof for several types of paper was adopted as a ratio of color fastness to rubbing. This numerical value represents the proportion of the density of the residual image to that of the original image, and it is indicated that as the numerical value is larger, the abrasion resistant performance is higher. For example, a ratio of color fastness to rubbing of 0.8 indicates that the density of a residual image which remains after an image having an image density of 1.5 is rubbed is 1.2.

The ratio of color fastness to rubbing versus the proportion of the color developing agent is shown in Table 3.

In the case of this formulation using 1.5% secondary aminobisphenol A, the powder density was 0.83 and therefore, the color development was determined to be good. Further, the erasing ratio was 0.077, and therefore, the color erasure was determined to be good.

The ratio of color fastness to rubbing was 0.92, and therefore the performance of color fastness to rubbing was determined to be good. Further, by a paper feed test in which 10000 sheets of paper were fed through MFP (e-studio 351) manufactured by Toshiba Tec Corporation, it was found that fixing can be performed without any problems.

### Comparative Example 1

Toner particles were prepared using 2% ethyl gallate as a color developing agent.

### Preparation of Toner Particles

### Composition of Sample

CVL: 3.8 g

S205: 0.5 g

Polypropylene wax: 1.0 g

LR-147: 1.0 g

Ethyl gallate: 5 g

Styrene-butadiene copolymer: 36.9 g

α-methylstyrene-styrene copolymer oligomer: 8.9 g

Polyester resin: 45.9 g

In the above sample, CVL (a leuco dye manufactured by Yamada Chemical Co., Ltd.) and 2-anilino-6-(N-ethyl-N-isopentylamino)-3-methylfluoran (a leuco dye S205, manufactured by Yamada Chemical Co., Ltd.) as color developable compounds, ethyl gallate (EG) as a color developing agent, polypropylene wax as a wax component, a charge control agent (LR-147, manufactured by Japan Carlit Co., Ltd.), and a blend of a styrene-butadiene copolymer having a weight ratio of butadiene of 10 wt %, an α-methylstyrene-styrene copolymer oligomer, and a polyester resin (XPE 2007, manufactured by Mitsui Chemicals, Inc.) at a weight ratio of 4:1:5 as a binder resin were used.

The respective materials were sufficiently mixed using a Henschel mixer, and the resulting mixture was kneaded and dispersed using a triple roll (at a temperature of 140° C.). Further, the kneaded material was processed into fine powder having an average particle diameter of 6.8±0.5 μm using a crusher, whereby toner particles were obtained. This fine powder was measured for powder density using a colorimeter CR-300 manufactured by Minolta Co., Ltd. (using a powder measurement cell). This powder density is a value calculated as a common logarithm of the reciprocal of the reflectivity. As the proportion of the color developable compound in a color developed state is higher, a higher powder density is obtained. The measurement results of the powder density are shown in FIG. 1 and Table 1.

In the case of this formulation using 2% ethyl gallate, the powder density was 0.52 and therefore, the color development was determined to be poor. Further, the erasing ratio was 0.108, and therefore, the color erasure was determined to be poor.

### Comparative Example 2

Toner particles were prepared using 5% ethyl gallate as a color developing agent.

### Preparation of Toner Particles

### Composition of Sample

CVL: 3.8 g

S205: 0.5 g

Polypropylene wax: 1.0 g

LR-147: 1.0 g

Ethyl gallate: 5 g

Styrene-butadiene copolymer: 36.9 g

α-methylstyrene-styrene copolymer oligomer: 8.9 g

Polyester resin: 45.9 g

In the above sample, CVL (a leuco dye manufactured by Yamada Chemical Co., Ltd.) and 2-anilino-6-(N-ethyl-N-isopentylamino)-3-methylfluoran (a leuco dye S205, manufactured by Yamada Chemical Co., Ltd.) as color developable compounds, ethyl gallate (EG) as a color developing agent, polypropylene wax as a wax component, a charge control agent (LR-147, manufactured by Japan Carlit Co., Ltd.), and a blend of a styrene-butadiene copolymer having a weight ratio of butadiene of 10 wt %, an α-methylstyrene-styrene copolymer oligomer, and a polyester resin (XPE 2007, manufactured by Mitsui Chemicals, Inc.) at a weight ratio of 4:1:5 as a binder resin were used.

The respective materials were sufficiently mixed using a Henschel mixer, and the resulting mixture was kneaded and dispersed using a triple roll (at a temperature of 140° C.). Further, the kneaded material was processed into fine powder having an average particle diameter of 6.8±0.5 μm using a crusher, whereby a blue electrophotographic toner was obtained. Hydrophobic silica was externally added to the thus prepared toner in an amount of 1 wt % of the total amount of the toner. The resulting toner was used for printing a patch pattern with several stages of image ID was printed on a sheet of copy paper using MFP (e-studio 351) manufactured by Toshiba Tec Corporation and a color fastness to rubbing test was performed using a color fastness to rubbing tester RT-300 manufactured by Daiei Kagaku Seiki Mfg. Co., Ltd. The tester was set as follows: testing table shape: curved surface (radius: 200 mm), rubbing finger shape: curved surface (radius: 45 mm), testing load: 2 N, reciprocating rubbing distance: 120 mm, and reciprocating rubbing speed: 5 times. The performance of color fastness to rubbing was determined as follows. A slope of a regression line of data obtained by plotting a value of [(original image ID)−(paper ID)] before testing on the horizontal axis and plotting a value of [(residual image ID)−(paper ID)] after testing on the vertical axis was determined for each paper to be evaluated, and an arithmetic average thereof for several types of paper was adopted as a ratio of color fastness to rubbing. This numerical value represents the proportion of the density of the residual image to that of the original image, and it is indicated that as the numerical value is larger, the abrasion resistant performance is higher. For example, a ratio of color fastness to rubbing of 0.8 indicates that the density of a residual image which remains after an image having an image density of 1.5 is rubbed is 1.2.

In the case of this formulation using 5% ethyl gallate, the powder density was 0.38 and therefore, the color development was determined to be poor. Further, the erasing ratio was 0.267, and therefore, the color erasure was determined to be poor.

The ratio of color fastness to rubbing was 0.39, and therefore the performance of color fastness to rubbing was determined to be poor. Further, by a paper feed test in which 10000 sheets of paper were fed, a fixing belt got significantly dirty, and therefore the fixing performance was determined to be poor due to offset.

### Example 3

### Preparation of Catechol Derivative

### Preparation of Color Developing Agent (Nitration)

Methylene chloride: 60 g

Catechol: 30 g

Concentrated nitric acid (concentration: 60%, density: 1.38 g/cm³): 10 g

After methylene chloride and catechol were mixed in a three-neck flask, a thermometer, a cooling tube, and a dropping funnel were connected thereto. Then, the mixture was cooled to 0° C. while moderately stirring, and concentrated nitric acid was added dropwise thereto through the dropping funnel such that the temperature of the content was 5° C. or lower. After 30 minutes from the completion of the dropwise addition, an aqueous solution of sodium bicarbonate was slowly added thereto. After completion of neutralization, an oil layer was obtained with a separating funnel. While moderately stirring the oil layer, 1-hexane was added thereto to obtain a precipitate. The precipitate was sufficiently dried, whereby a nitrated intermediate was obtained. By performing GC-MS, H¹-NMR, and C¹³-NMR, it was found that a 98% nitrated catechol compound was obtained.

### Preparation of Color Developing Agent (Hydrogenation)

DMF: 79 g

Nitrated catechol compound: 20 g

5% Palladium catalyst: 1 g

DMF, the nitrated catechol compound, and a magnetic stirrer were put in a 200 cc stainless steel autoclave, and further a 5% palladium catalyst was added thereto. Then, the mixture was moderately stirred and sufficiently subjected to nitrogen replacement, followed by hydrogen replacement, and then, 99.9% hydrogen was slowly filled into the autoclave to a pressure of 0.3 MPa. The mixture was heated to 80° C. in an oil bath, and pressurization was continued so as to maintain a constant pressure of 0.3 MPa. The pressurization was stopped when hydrogen was no longer consumed, and the resulting mixture was cooled to room temperature, and then sufficiently subjected to nitrogen replacement. Then, the content was taken out and distilled water was added thereto, whereby a precipitate was obtained. Then, the precipitate was sufficiently washed and dried. By performing GC-MS, H¹-NMR, and C¹³-NMR, it was found that a 98% primary aminocatechol compound was obtained.

### Preparation of Color Developing Agent (Alkylation)

1-Propanol: 79 g

Primary aminocatechol compound: 20 g

5% nickel-copper mixed catalyst: 1 g

1-Propanol, the primary aminocatechol compound, and a magnetic stirrer were put in a 200 cc stainless steel autoclave, and further a 5% nickel-copper catalyst was added thereto. Then, the mixture was moderately stirred and sufficiently subjected to nitrogen replacement. Subsequently, the mixture was heated to 120° C. in an oil bath and maintained for 5 hours. The resulting mixture was cooled to room temperature, and the content was taken out and distilled water was added thereto, whereby a precipitate was obtained. Then, the precipitate was sufficiently dried. By performing GC-MS, H¹-NMR, and C¹³-NMR, it was found that, as a catechol derivative, a 98% secondary aminocatechol compound was obtained.

The structure of the thus obtained catechol derivative is represented by the following formula (5).

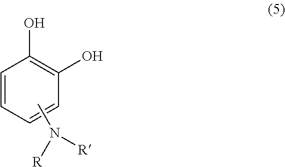

In the above formula (5), R represents hydrogen, alkyl, alkene, a benzene ring, a heterocyclic ring, cycloalkane, or cycloalkene; and R′ represents hydrogen, alkyl, alkene, a benzene ring, a heterocyclic ring, cycloalkane, or cycloalkene.

In the catechol derivative represented by the formula (5), an amino group is located at the ortho and meta positions.

### Preparation of Toner Particles

### Composition of Sample

CVL: 3.8 g

S205: 0.5 g

Polypropylene wax: 1.0 g

LR-147: 1.0 g

Secondary aminocatechol: 2 g

Styrene-butadiene copolymer: 36.9 g

α-methylstyrene-styrene copolymer oligomer: 8.9 g

Polyester resin: 45.9 g

In the above sample, CVL (a leuco dye manufactured by Yamada Chemical Co., Ltd.) and 2-anilino-6-(N-ethyl-N-isopentylamino)-3-methylfluoran (a leuco dye S205, manufactured by Yamada Chemical Co., Ltd.) as color developable compounds, secondary aminocatechol as a color developing agent, polypropylene wax as a wax component, a charge control agent (LR-147, manufactured by Japan Carlit Co., Ltd.), and a blend of a styrene-butadiene copolymer having a weight ratio of butadiene of 10 wt %, an α-methylstyrene-styrene copolymer oligomer, and a polyester resin (XPE 2007, manufactured by Mitsui Chemicals, Inc.) at a weight ratio of 4:1:5 as a binder resin were used.

The respective materials were sufficiently mixed using a Henschel mixer, and the resulting mixture was kneaded and dispersed using a triple roll (at a temperature of 140° C.). Further, the kneaded material was processed into fine powder having an average particle diameter of 6.8±0.5 μm using a crusher, whereby a blue electrophotographic toner was obtained. This fine powder was measured for powder density using a colorimeter CR-300 manufactured by Minolta Co., Ltd. (using a powder measurement cell). This powder density is a value calculated as a common logarithm of the reciprocal of the reflectivity. As the proportion of the color developable compound in a color developed state is higher, a higher powder density is obtained. The measurement results of the powder density are shown in FIG. 1 and Table 1.

Hydrophobic silica was externally added to the thus prepared toner in an amount of 1 wt % of the total amount of the toner. The resulting toner was used for printing a solid pattern with several stages of image ID on a sheet of copy paper using MFP (e-studio 351) manufactured by Toshiba Tec Corporation to prepare images for evaluating erasing performance. The image was erased by heating at 130° C. for 2 hours using a constant temperature chamber. The erasing performance was determined as follows. A slope of a regression line of data obtained by plotting a value of [(original image ID)−(paper ID)] before erasure by heating on the horizontal axis and plotting a value of [(residual image ID)−(paper ID)] after erasure by heating on the vertical axis was determined for each paper to be evaluated, and an arithmetic average thereof for several types of paper was adopted as an erasing ratio. This numerical value represents the proportion of the density of the residual image to that of the original image, and it is indicated that as the numerical value is smaller, the heat erasing performance is higher. For example, a heat erasing ratio of 0.05 indicates that the density of a residual image which remains after an image having an image density of 1.0 is erased by heating is 0.05. The erasing ratio versus the proportion of the color developing agent is shown in FIG. 2 and Table 2.

Further, a patch pattern with several stages of image ID was printed on a sheet of copy paper and a color fastness to rubbing test was performed using a color fastness to rubbing tester RT-300 manufactured by Daiei Kagaku Seiki Mfg. Co., Ltd. The tester was set as follows: testing table shape: curved surface (radius: 200 mm), rubbing finger shape: curved surface (radius: 45 mm), testing load: 2 N, reciprocating rubbing distance: 120 mm, and reciprocating rubbing speed: 5 times. The performance of color fastness to rubbing was determined as follows. A slope of a regression line of data obtained by plotting a value of [(original image ID)−(paper ID)] before testing on the horizontal axis and plotting a value of [(residual image ID)−(paper ID)] after testing on the vertical axis was determined for each paper to be evaluated, and an arithmetic average thereof for several types of paper was adopted as a ratio of color fastness to rubbing. This numerical value represents the proportion of the density of the residual image to that of the original image, and it is indicated that as the numerical value is larger, the abrasion resistant performance is higher. For example, a ratio of color fastness to rubbing of 0.8 indicates that the density of a residual image which remains after an image having an image density of 1.5 is rubbed is 1.2. The ratio of color fastness to rubbing versus the proportion of the color developing agent is shown in Table 3.

In the case of this formulation using 2% secondary aminocatechol, the powder density was 0.82 and therefore, the color development was determined to be good. Further, the erasing ratio was 0.079, and therefore, the color erasure was determined to be good.

The ratio of color fastness to rubbing was 0.92, and therefore the performance of color fastness to rubbing was determined to be good. Further, by a paper feed test in which 10000 sheets of paper were fed through MFP (e-studio 351) manufactured by Toshiba Tec Corporation, it was found that fixing can be performed without any problems.

### Example 4

### Preparation of Hydroquinone Derivative

### Preparation of Color Developing Agent (Nitration)

Methylene chloride: 60 g

Hydroquinone: 30 g

Concentrated nitric acid (concentration: 60%, density: 1.38 g/cm³): 10 g

After methylene chloride and hydroquinone were mixed in a three-neck flask, a thermometer, a cooling tube, and a dropping funnel were connected thereto. Then, the mixture was cooled to 0° C. while moderately stirring, and concentrated nitric acid was added dropwise thereto through the dropping funnel such that the temperature of the content was 5° C. or lower. After 30 minutes from the completion of the dropwise addition, an aqueous solution of sodium bicarbonate was slowly added thereto. After completion of neutralization, an oil layer was obtained with a separating funnel. While moderately stirring the oil layer, 1-hexane was added thereto to obtain a precipitate. The precipitate was sufficiently dried, whereby a nitrated intermediate was obtained. By performing GC-MS, H¹-NMR, and C¹³-NMR, it was found that a 98% nitrated hydroquinone compound was obtained.

### Preparation of Color Developing Agent (Hydrogenation)

DMF: 79 g

Nitrated hydroquinone compound: 20 g

5% Palladium catalyst: 1 g

DMF, the nitrated hydroquinone compound, and a magnetic stirrer were put in a 200 cc stainless steel autoclave, and further a 5% palladium catalyst was added thereto. Then, the mixture was moderately stirred and sufficiently subjected to nitrogen replacement, followed by hydrogen replacement, and then, 99.9% hydrogen was slowly filled into the autoclave to a pressure of 0.3 MPa. The mixture was heated to 80° C. in an oil bath, and pressurization was continued so as to maintain a constant pressure of 0.3 MPa. The pressurization was stopped when hydrogen was no longer consumed, and the resulting mixture was cooled to room temperature, and then sufficiently subjected to nitrogen replacement. Then, the content was taken out and distilled water was added thereto, whereby a precipitate was obtained. Then, the precipitate was sufficiently washed and dried. By performing GC-MS, H¹-NMR, and C¹³-NMR, it was found that a 98% primary aminohydroquinone compound was obtained.

### Preparation of Color Developing Agent (Alkylation)

1-Propanol: 79 g

Primary aminohydroquinone compound: 20 g

5% nickel-copper mixed catalyst: 1 g

1-Propanol, the primary aminohydroquinone compound, and a magnetic stirrer were put in a 200 cc stainless steel autoclave, and further a 5% nickel-copper catalyst was added thereto. Then, the mixture was moderately stirred and sufficiently subjected to nitrogen replacement. Subsequently, the mixture was heated to 120° C. in an oil bath and maintained for 5 hours. The resulting mixture was cooled to room temperature, and the content was taken out and distilled water was added thereto, whereby a precipitate was obtained. Then, the precipitate was sufficiently dried. By performing GC-MS, H¹-NMR, and C¹³-NMR, it was found that, as a hydroquinone derivative, a 98% secondary aminohydroquinone compound was obtained. The structure of the thus obtained secondary aminohydroquinone compound is represented by the following formula (6).

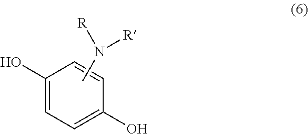

In the above formula (6), R represents hydrogen, alkyl, alkene, a benzene ring, a heterocyclic ring, cycloalkane, or cycloalkene; and R′ represents hydrogen, alkyl, alkene, a benzene ring, a heterocyclic ring, cycloalkane, or cycloalkene.

In the hydroquinone derivative represented by the formula (6), an amino group is located at the ortho and meta positions.

### Preparation of Toner Particles

### Composition of Sample

CVL: 3.8 g

S205: 0.5 g

Polypropylene wax: 1.0 g

LR-147: 1.0 g

Secondary aminohydroquinone: 2 g

Styrene-butadiene copolymer: 36.9 g

α-methylstyrene-styrene copolymer oligomer: 8.9 g

Polyester resin: 45.9 g

In the above sample, CVL (a leuco dye manufactured by Yamada Chemical Co., Ltd.) and 2-anilino-6-(N-ethyl-N-isopentylamino)-3-methylfluoran (a leuco dye S205, manufactured by Yamada Chemical Co., Ltd.) as color developable compounds, secondary aminohydroquinone as a color developing agent, polypropylene wax as a wax component, a charge control agent (LR-147, manufactured by Japan Carlit Co., Ltd.), and a blend of a styrene-butadiene copolymer having a weight ratio of butadiene of 10 wt %, an α-methylstyrene-styrene copolymer oligomer, and a polyester resin (XPE 2007, manufactured by Mitsui Chemicals, Inc.) at a weight ratio of 4:1:5 as a binder resin were used.

The respective materials were sufficiently mixed using a Henschel mixer, and the resulting mixture was kneaded and dispersed using a triple roll (at a temperature of 140° C.). Further, the kneaded material was processed into fine powder having an average particle diameter of 6.8±0.5 μm using a crusher, whereby a blue electrophotographic toner was obtained. This fine powder was measured for powder density using a colorimeter CR-300 manufactured by Minolta Co., Ltd. (using a powder measurement cell). This powder density is a value calculated as a common logarithm of the reciprocal of the reflectivity. As the proportion of the color developable compound in a color developed state is higher, a higher powder density is obtained. The measurement results of the powder density are shown in FIG. 1 and Table 1.

Hydrophobic silica was externally added to the thus prepared toner in an amount of 1 wt % of the total amount of the toner. The resulting toner was used for printing a solid pattern with several stages of image ID on a sheet of copy paper using MFP (e-studio 351) manufactured by Toshiba Tec Corporation to prepare images for evaluating erasing performance. The image was erased by heating at 130° C. for 2 hours using a constant temperature chamber. The erasing performance was determined as follows. A slope of a regression line of data obtained by plotting a value of [(original image ID)−(paper ID)] before erasure by heating on the horizontal axis and plotting a value of [(residual image ID)−(paper ID)] after erasure by heating on the vertical axis was determined for each paper to be evaluated, and an arithmetic average thereof for several types of paper was adopted as an erasing ratio. This numerical value represents the proportion of the density of the residual image to that of the original image, and it is indicated that as the numerical value is smaller, the heat erasing performance is higher. For example, a heat erasing ratio of 0.05 indicates that the density of a residual image which remains after an image having an image density of 1.0 is erased by heating is 0.05. The erasing ratio versus the proportion of the color developing agent is shown in FIG. 2 and Table 2.

Further, a patch pattern with several stages of image ID was printed on a sheet of copy paper and a color fastness to rubbing test was performed using a color fastness to rubbing tester RT-300 manufactured by Daiei Kagaku Seiki Mfg. Co., Ltd. The tester was set as follows: testing table shape: curved surface (radius: 200 mm), rubbing finger shape: curved surface (radius: 45 mm), testing load: 2 N, reciprocating rubbing distance: 120 mm, and reciprocating rubbing speed: 5 times. The performance of color fastness to rubbing was determined as follows. A slope of a regression line of data obtained by plotting a value of [(original image ID)−(paper ID)] before testing on the horizontal axis and plotting a value of [(residual image ID)−(paper ID)] after testing on the vertical axis was determined for each paper to be evaluated, and an arithmetic average thereof for several types of paper was adopted as a ratio of color fastness to rubbing. This numerical value represents the proportion of the density of the residual image to that of the original image, and it is indicated that as the numerical value is larger, the abrasion resistant performance is higher. For example, a ratio of color fastness to rubbing of 0.8 indicates that the density of a residual image which remains after an image having an image density of 1.5 is rubbed is 1.2.

The ratio of color fastness to rubbing versus the proportion of the color developing agent is shown in Table 3.

In the case of this formulation using 2% secondary aminohydroquinone, the powder density was 0.80 and therefore, the color development was determined to be good. Further, the erasing ratio was 0.079, and therefore, the color erasure was determined to be good.

The ratio of color fastness to rubbing was 0.89, and therefore the performance of color fastness to rubbing was determined to be good. Further, by a paper feed test in which 10000 sheets of paper were fed through MFP (e-studio 351) manufactured by Toshiba Tec Corporation, it was found that fixing can be performed without any problems.

### Example 5

### Preparation of Naphthol Derivative

### Preparation of Color Developing Agent (Nitration)

Methylene chloride: 60 g

Naphthol: 30 g

Concentrated nitric acid (concentration: 60%, density: 1.38 g/cm³): 10 g

After methylene chloride and naphthol were mixed in a three-neck flask, a thermometer, a cooling tube, and a dropping funnel were connected thereto. Then, the mixture was cooled to 0° C. while moderately stirring, and concentrated nitric acid was added dropwise thereto through the dropping funnel such that the temperature of the content was 5° C. or lower. After 30 minutes from the completion of the dropwise addition, an aqueous solution of sodium bicarbonate was slowly added thereto. After completion of neutralization, an oil layer was obtained with a separating funnel. While moderately stirring the oil layer, 1-hexane was added thereto to obtain a precipitate. The precipitate was sufficiently dried, whereby a nitrated intermediate was obtained. By performing GC-MS, H¹-NMR, and C¹³-NMR, it was found that a 98% nitrated naphthol compound was obtained.

### Preparation of Color Developing Agent (Hydrogenation)

DMF: 79 g

Nitrated naphthol: 20 g

5% Palladium catalyst: 1 g

DMF, the nitrated intermediate, and a magnetic stirrer were put in a 200 cc stainless steel autoclave, and further a 5% palladium catalyst was added thereto. Then, the mixture was moderately stirred and sufficiently subjected to nitrogen replacement, followed by hydrogen replacement, and then, 99.9% hydrogen was slowly filled into the autoclave to a pressure of 0.3 MPa. The mixture was heated to 80° C. in an oil bath, and pressurization was continued so as to maintain a constant pressure of 0.3 MPa. The pressurization was stopped when hydrogen was no longer consumed, and the resulting mixture was cooled to room temperature, and then sufficiently subjected to nitrogen replacement. Then, the content was taken out and distilled water was added thereto, whereby a precipitate was obtained. Then, the precipitate was sufficiently washed and dried. By performing GC-MS, H¹-NMR, and C¹³-NMR, it was found that a 98% primary aminonaphthol compound was obtained.

### Preparation of Color Developing Agent (Alkylation)

1-Butanol: 79 g

Primary aminonaphthol compound: 20 g

5% nickel mixed catalyst: 1 g

1-Butanol, the primary aminonaphthol compound, and a magnetic stirrer were put in a 200 cc stainless steel autoclave, and further a 5% nickel mixed catalyst was added thereto. Then, the mixture was moderately stirred and sufficiently subjected to nitrogen replacement. Subsequently, the mixture was heated to 120° C. in an oil bath and maintained for 5 hours. The resulting mixture was cooled to room temperature, and the content was taken out and distilled water was added thereto, whereby a precipitate was obtained. Then, the precipitate was sufficiently dried. By performing GC-MS, H¹-NMR, and C¹³-NMR, it was found that, as a naphthol derivative, a 98% secondary aminonaphthol compound was obtained.

The structure of the thus obtained secondary aminonaphthol compound is represented by the following formula (7).

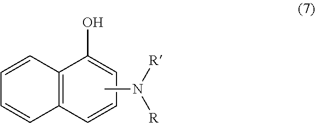

In the above formula (7), R represents hydrogen, alkyl, alkene, a benzene ring, a heterocyclic ring, cycloalkane, or cycloalkene; and R′ represents hydrogen, alkyl, alkene, a benzene ring, a heterocyclic ring, cycloalkane, or cycloalkene.

In the naphthol derivative represented by the formula (7), an amino group is located at the ortho position relative to one hydroxy group.

### Preparation of Toner Particles

### Composition of Sample

CVL: 3.8 g

S205: 0.5 g

Polypropylene wax: 1.0 g

LR-147: 1.0 g

Secondary aminonaphthol: 1.5 g

Styrene-butadiene copolymer: 36.9 g

α-methylstyrene-styrene copolymer oligomer: 8.9 g

Polyester resin: 45.9 g

In the above sample, CVL (a leuco dye manufactured by Yamada Chemical Co., Ltd.) and 2-anilino-6-(N-ethyl-N-isopentylamino)-3-methylfluoran (a leuco dye S205, manufactured by Yamada Chemical Co., Ltd.) as color developable compounds, secondary aminonaphthol as a color developing agent, polypropylene wax as a wax component, a charge control agent (LR-147, manufactured by Japan Carlit Co., Ltd.), and a blend of a styrene-butadiene copolymer having a weight ratio of butadiene of 10 wt %, an α-methylstyrene-styrene copolymer oligomer, and a polyester resin (XPE 2007, manufactured by Mitsui Chemicals, Inc.) at a weight ratio of 4:1:5 as a binder resin were used.

The respective materials were sufficiently mixed using a Henschel mixer, and the resulting mixture was kneaded and dispersed using a triple roll (at a temperature of 140° C.). Further, the kneaded material was processed into fine powder having an average particle diameter of 6.8±0.5 μm using a crusher, whereby a blue electrophotographic toner was obtained. This fine powder was measured for powder density using a colorimeter CR-300 manufactured by Minolta Co., Ltd. (using a powder measurement cell). This powder density is a value calculated as a common logarithm of the reciprocal of the reflectivity. As the proportion of the color developable compound in a color developed state is higher, a higher powder density is obtained. The measurement results of the powder density are shown in FIG. 1 and Table 1.

Hydrophobic silica was externally added to the thus prepared toner in an amount of 1 wt % of the total amount of the toner. The resulting toner was used for printing a solid pattern with several stages of image ID on a sheet of copy paper using MFP (e-studio 351) manufactured by Toshiba Tec Corporation to prepare images for evaluating erasing performance. The image was erased by heating at 130° C. for 2 hours using a constant temperature chamber. The erasing performance was determined as follows. A slope of a regression line of data obtained by plotting a value of [(original image ID)−(paper ID)] before erasure by heating on the horizontal axis and plotting a value of [(residual image ID)−(paper ID)] after erasure by heating on the vertical axis was determined for each paper to be evaluated, and an arithmetic average thereof for several types of paper was adopted as an erasing ratio. This numerical value represents the proportion of the density of the residual image to that of the original image, and it is indicated that as the numerical value is smaller, the heat erasing performance is higher. For example, a heat erasing ratio of 0.05 indicates that the density of a residual image which remains after an image having an image density of 1.0 is erased by heating is 0.05. The erasing ratio versus the proportion of the color developing agent is shown in FIG. 2 and Table 2.

In addition, a patch pattern with several stages of image ID was printed on a sheet of copy paper and a color fastness to rubbing test was performed using a color fastness to rubbing tester RT-300 manufactured by Daiei Kagaku Seiki Mfg. Co., Ltd. The tester was set as follows: testing table shape: curved surface (radius: 200 mm), rubbing finger shape: curved surface (radius: 45 mm), testing load: 2 N, reciprocating rubbing distance: 120 mm, and reciprocating rubbing speed: 5 times. The performance of color fastness to rubbing was determined as follows. A slope of a regression line of data obtained by plotting a value of [(original image ID)−(paper ID)] before testing on the horizontal axis and plotting a value of [(residual image ID)−(paper ID)] after testing on the vertical axis was determined for each paper to be evaluated, and an arithmetic average thereof for several types of paper was adopted as a ratio of color fastness to rubbing. This numerical value represents the proportion of the density of the residual image to that of the original image, and it is indicated that as the numerical value is larger, the abrasion resistant performance is higher. For example, a ratio of color fastness to rubbing of 0.8 indicates that the density of a residual image which remains after an image having an image density of 1.5 is rubbed is 1.2.

The ratio of color fastness to rubbing versus the proportion of the color developing agent is shown in Table 3.

In the case of this formulation using 1.5% secondary aminonaphthol, the powder density was 0.81 and therefore, the color development was determined to be good. Further, the erasing ratio was 0.07, and therefore, the color erasure was determined to be good.

The ratio of color fastness to rubbing was 0.92, and therefore the performance of color fastness to rubbing was determined to be good. Further, by a paper feed test in which 10000 sheets of paper were fed through MFP (e-studio 351) manufactured by Toshiba Tec Corporation, it was found that fixing can be performed without any problems.

### Example 6

### Preparation of 2,3-dihydroxynaphthalene derivative

### Preparation of Color Developing Agent (Nitration)

Methylene chloride: 60 g

2,3-Dihydroxynaphthalene: 30 g

Concentrated nitric acid (concentration: 60%, density: 1.38 g/cm³): 10 g

After methylene chloride and 2,3-dihydroxynaphthalene were mixed in a three-neck flask, a thermometer, a cooling tube, and a dropping funnel were connected thereto. Then, the mixture was cooled to 0° C. while moderately stirring, and concentrated nitric acid was added dropwise thereto through the dropping funnel such that the temperature of the content was 5° C. or lower. After 30 minutes from the completion of the dropwise addition, an aqueous solution of sodium bicarbonate was slowly added thereto. After completion of neutralization, an oil layer was obtained with a separating funnel. While moderately stirring the oil layer, 1-hexane was added thereto to obtain a precipitate. The precipitate was sufficiently dried, whereby a nitrated intermediate was obtained. By performing GC-MS, H¹-NMR, and C¹³-NMR, it was found that a 98% nitrated 2,3-dihydroxynaphthalene compound was obtained.

### Preparation of Color Developing Agent (Hydrogenation)

DMF: 79 g

Nitrated 2,3-dihydroxynaphthalene: 20 g

5% Palladium catalyst: 1 g

DMF, the nitrated intermediate, and a magnetic stirrer were put in a 200 cc stainless steel autoclave, and further a 5% palladium catalyst was added thereto. Then, the mixture was moderately stirred and sufficiently subjected to nitrogen replacement, followed by hydrogen replacement, and then, 99.9% hydrogen was slowly filled into the autoclave to a pressure of 0.3 MPa. The mixture was heated to 80° C. in an oil bath, and pressurization was continued so as to maintain a constant pressure of 0.3 MPa. The pressurization was stopped when hydrogen was no longer consumed, and the resulting mixture was cooled to room temperature, and then sufficiently subjected to nitrogen replacement. Then, the content was taken out and distilled water was added thereto, whereby a precipitate was obtained. Then, the precipitate was sufficiently washed and dried. By performing GC-MS, H¹-NMR, and C¹³-NMR, it was found that a 98% primary amino-2,3-dihydroxynaphthalene compound was obtained.

### Preparation of Color Developing Agent (Alkylation)

1-Butanol: 79 g

Primary amino-2,3-dihydroxynaphthalene compound: 20 g

5% nickel mixed catalyst: 1 g

1-Butanol, the primary amino-2,3-dihydroxynaphthalene compound, and a magnetic stirrer were put in a 200 cc stainless steel autoclave, and further a 5% nickel mixed catalyst was added thereto. Then, the mixture was moderately stirred and sufficiently subjected to nitrogen replacement. Subsequently, the mixture was heated to 120° C. in an oil bath and maintained for 5 hours. The resulting mixture was cooled to room temperature, and the content was taken out and distilled water was added thereto, whereby a precipitate was obtained. Then, the precipitate was sufficiently dried. By performing GC-MS, H¹-NMR, and C¹³-NMR, it was found that a 98% secondary amino-2,3-dihydroxynaphthalene compound was obtained.

The thus obtained secondary amino-2,3-dihydroxynaphthalene compound is represented by the following formula (8).

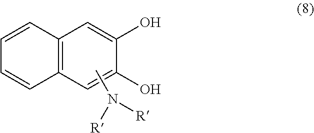

In the above formula (8), R represents hydrogen, alkyl, alkene, a benzene ring, a heterocyclic ring, cycloalkane, or cycloalkene; and R′ represents hydrogen, alkyl, alkene, a benzene ring, a heterocyclic ring, cycloalkane, or cycloalkene.

In the 2,3-dihydroxynaphthalene derivative represented by the formula (8), one amino group is located relative to two hydroxy groups at the ortho position and at the meta position, respectively.

### Preparation of Toner Particles

### Composition of Sample

CVL: 3.8 g

S205: 0.5 g

Polypropylene wax: 1.0 g

LR-147: 1.0 g

Secondary amino-2,3-dihydroxynaphthalene: 1.5 g

Styrene-butadiene copolymer: 36.9 g

α-methylstyrene-styrene copolymer oligomer: 8.9 g

Polyester resin: 45.9 g

In the above sample, CVL (a leuco dye manufactured by Yamada Chemical Co., Ltd.) and 2-anilino-6-(N-ethyl-N-isopentylamino)-3-methylfluoran (a leuco dye S205, manufactured by Yamada Chemical Co., Ltd.) as color developable compounds, secondary amino-2,3-dihydroxynaphthalene as a color developing agent, polypropylene wax as a wax component, a charge control agent (LR-147, manufactured by Japan Carlit Co., Ltd.), and a blend of a styrene-butadiene copolymer having a weight ratio of butadiene of 10 wt %, an α-methylstyrene-styrene copolymer oligomer, and a polyester resin (XPE 2007, manufactured by Mitsui Chemicals, Inc.) at a weight ratio of 4:1:5 as a binder resin were used.

The respective materials were sufficiently mixed using a Henschel mixer, and the resulting mixture was kneaded and dispersed using a triple roll (at a temperature of 140° C.). Further, the kneaded material was processed into fine powder having an average particle diameter of 6.8±0.5 μm using a crusher, whereby a blue electrophotographic toner was obtained. This fine powder was measured for powder density using a colorimeter CR-300 manufactured by Minolta Co., Ltd. (using a powder measurement cell). This powder density is a value calculated as a common logarithm of the reciprocal of the reflectivity. As the proportion of the color developable compound in a color developed state is higher, a higher powder density is obtained. The measurement results of the powder density are shown in FIG. 1 and Table 1.

Hydrophobic silica was externally added to the thus prepared toner in an amount of 1 wt % of the total amount of the toner. The resulting toner was used for printing a solid pattern with several stages of image ID on a sheet of copy paper using MFP (e-studio 351) manufactured by Toshiba Tec Corporation to prepare images for evaluating erasing performance. The image was erased by heating at 130° C. for 2 hours using a constant temperature chamber. The erasing performance was determined as follows. A slope of a regression line of data obtained by plotting a value of [(original image ID)−(paper ID)] before erasure by heating on the horizontal axis and plotting a value of [(residual image ID)−(paper ID)] after erasure by heating on the vertical axis was determined for each paper to be evaluated, and an arithmetic average thereof for several types of paper was adopted as an erasing ratio. This numerical value represents the proportion of the density of the residual image to that of the original image, and it is indicated that as the numerical value is smaller, the heat erasing performance is higher. For example, a heat erasing ratio of 0.05 indicates that the density of a residual image which remains after an image having an image density of 1.0 is erased by heating is 0.05. The erasing ratio versus the proportion of the color developing agent is shown in FIG. 2 and Table 2.

In addition, a patch pattern with several stages of image ID was printed on a sheet of copy paper and a color fastness to rubbing test was performed using a color fastness to rubbing tester RT-300 manufactured by Daiei Kagaku Seiki Mfg. Co., Ltd. The tester was set as follows: testing table shape: curved surface (radius: 200 mm), rubbing finger shape: curved surface (radius: 45 mm), testing load: 2 N, reciprocating rubbing distance: 120 mm, and reciprocating rubbing speed: 5 times. The performance of color fastness to rubbing was determined as follows. A slope of a regression line of data obtained by plotting a value of [(original image ID)−(paper ID)] before testing on the horizontal axis and plotting a value of [(residual image ID)−(paper ID)] after testing on the vertical axis was determined for each paper to be evaluated, and an arithmetic average thereof for several types of paper was adopted as a ratio of color fastness to rubbing. This numerical value represents the proportion of the density of the residual image to that of the original image, and it is indicated that as the numerical value is larger, the abrasion resistant performance is higher. For example, a ratio of color fastness to rubbing of 0.8 indicates that the density of a residual image which remains after an image having an image density of 1.5 is rubbed is 1.2. The ratio of color fastness to rubbing versus the proportion of the color developing agent is shown in Table 3.

In the case of this formulation using 1.5% secondary amino-2,3-dihydroxynaphthalene, the powder density was 0.79 and therefore, the color development was determined to be good. Further, the erasing ratio was 0.069, and therefore, the color erasure was determined to be good.

The ratio of color fastness to rubbing was 0.89, and therefore the performance of color fastness to rubbing was determined to be good. Further, by a paper feed test in which 10000 sheets of paper were fed through MFP (e-studio 351) manufactured by Toshiba Tec Corporation, it was found that fixing can be performed without any problems.

### Example 7

### Preparation of Morphol Derivative

### Preparation of Color Developing Agent (Nitration)

Methylene chloride: 60 g

Morphol: 30 g

Concentrated nitric acid (concentration: 60%, density: 1.38 g/cm³): 10 g

After methylene chloride and morphol were mixed in a three-neck flask, a thermometer, a cooling tube, and a dropping funnel were connected thereto. Then, the mixture was cooled to 0° C. while moderately stirring, and concentrated nitric acid was added dropwise thereto through the dropping funnel such that the temperature of the content was 5° C. or lower. After 30 minutes from the completion of the dropwise addition, an aqueous solution of sodium bicarbonate was slowly added thereto. After completion of neutralization, an oil layer was obtained with a separating funnel. While moderately stirring the oil layer, 1-hexane was added thereto to obtain a precipitate. The precipitate was sufficiently dried, whereby a nitrated intermediate was obtained. By performing GC-MS, H¹-NMR, and C¹³-NMR, it was found that a 98% nitrated morphol compound was obtained.

### Preparation of Color Developing Agent (Hydrogenation)

DMF: 79 g

Nitrated morphol: 20 g

5% Palladium catalyst: 1 g

DMF, the nitrated intermediate, and a magnetic stirrer were put in a 200 cc stainless steel autoclave, and further a 5% palladium catalyst was added thereto. Then, the mixture was moderately stirred and sufficiently subjected to nitrogen replacement, followed by hydrogen replacement, and then, 99.9% hydrogen was slowly filled into the autoclave to a pressure of 0.3 MPa. The mixture was heated to 80° C. in an oil bath, and pressurization was continued so as to maintain a constant pressure of 0.3 MPa. The pressurization was stopped when hydrogen was no longer consumed, and the resulting mixture was cooled to room temperature, and then sufficiently subjected to nitrogen replacement. Then, the content was taken out and distilled water was added thereto, whereby a precipitate was obtained. Then, the precipitate was sufficiently washed and dried. By performing GC-MS, H¹-NMR, and C¹³-NMR, it was found that a 98% primary aminomorphol compound was obtained.

### Preparation of Color Developing Agent (Alkylation)

1-Butanol: 79 g

Primary aminomorphol compound: 20 g

5% nickel mixed catalyst: 1 g

1-Butanol, the primary aminomorphol compound, and a magnetic stirrer were put in a 200 cc stainless steel autoclave, and further a 5% nickel mixed catalyst was added thereto. Then, the mixture was moderately stirred and sufficiently subjected to nitrogen replacement. Subsequently, the mixture was heated to 120° C. in an oil bath and maintained for 5 hours. The resulting mixture was cooled to room temperature, and the content was taken out and distilled water was added thereto, whereby a precipitate was obtained. Then, the precipitate was sufficiently dried. By performing GC-MS, H¹-NMR, and C¹³-NMR, it was found that, as a morphol derivative, a 98% secondary aminomorphol compound was obtained.

The structure of the thus obtained secondary aminomorphol compound is represented by the following formula (9).

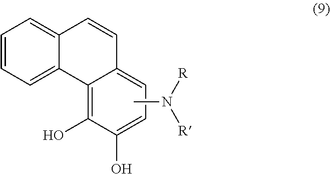

In the above formula (9), R represents hydrogen, alkyl, alkene, a benzene ring, a heterocyclic ring, cycloalkane, or cycloalkene; and R′ represents hydrogen, alkyl, alkene, a benzene ring, a heterocyclic ring, cycloalkane, or cycloalkene.

In the morphol derivative represented by the formula (9), an amino group is located relative to two hydroxy groups at the ortho and meta positions.

### Preparation of Toner Particles

### Composition of Sample

CVL: 3.8 g

S205: 0.5 g

Polypropylene wax: 1.0 g

LR-147: 1.0 g

Secondary aminomorphol: 1.5 g

Styrene-butadiene copolymer: 36.9 g

α-methylstyrene-styrene copolymer oligomer: 8.9 g

Polyester resin: 45.9 g

In the above sample, CVL (a leuco dye manufactured by Yamada Chemical Co., Ltd.) and 2-anilino-6-(N-ethyl-N-isopentylamino)-3-methylfluoran (a leuco dye S205, manufactured by Yamada Chemical Co., Ltd.) as color developable compounds, secondary aminomorphol as a color developing agent, polypropylene wax as a wax component, a charge control agent (LR-147, manufactured by Japan Carlit Co., Ltd.), and a blend of a styrene-butadiene copolymer having a weight ratio of butadiene of 10 wt %, an α-methylstyrene-styrene copolymer oligomer, and a polyester resin (XPE 2007, manufactured by Mitsui Chemicals, Inc.) at a weight ratio of 4:1:5 as a binder resin were used.

The respective materials were sufficiently mixed using a Henschel mixer, and the resulting mixture was kneaded and dispersed using a triple roll (at a temperature of 140° C.). Further, the kneaded material was processed into fine powder having an average particle diameter of 6.8±0.5 μm using a crusher, whereby a blue electrophotographic toner was obtained. This fine powder was measured for powder density using a colorimeter CR-300 manufactured by Minolta Co., Ltd. (using a powder measurement cell). This powder density is a value calculated as a common logarithm of the reciprocal of the reflectivity. As the proportion of the color developable compound in a color developed state is higher, a higher powder density is obtained. The measurement results of the powder density are shown in FIG. 1 and Table 1.

Hydrophobic silica was externally added to the thus prepared toner in an amount of 1 wt % of the total amount of the toner. The resulting toner was used for printing a solid pattern with several stages of image ID on a sheet of copy paper using MFP (e-studio 351) manufactured by Toshiba Tec Corporation to prepare images for evaluating erasing performance. The image was erased by heating at 130° C. for 2 hours using a constant temperature chamber. The erasing performance was determined as follows. A slope of a regression line of data obtained by plotting a value of [(original image ID)−(paper ID)] before erasure by heating on the horizontal axis and plotting a value of [(residual image ID)−(paper ID)] after erasure by heating on the vertical axis was determined for each paper to be evaluated, and an arithmetic average thereof for several types of paper was adopted as an erasing ratio. This numerical value represents the proportion of the density of the residual image to that of the original image, and it is indicated that as the numerical value is smaller, the heat erasing performance is higher. For example, a heat erasing ratio of 0.05 indicates that the density of a residual image which remains after an image having an image density of 1.0 is erased by heating is 0.05. The erasing ratio versus the proportion of the color developing agent is shown in FIG. 2 and Table 2.

In addition, a patch pattern with several stages of image ID was printed on a sheet of copy paper and a color fastness to rubbing test was performed using a color fastness to rubbing tester RT-300 manufactured by Daiei Kagaku Seiki Mfg. Co., Ltd. The tester was set as follows: testing table shape: curved surface (radius: 200 mm), rubbing finger shape: curved surface (radius: 45 mm), testing load: 2 N, reciprocating rubbing distance: 120 mm, and reciprocating rubbing speed: 5 times. The performance of color fastness to rubbing was determined as follows. A slope of a regression line of data obtained by plotting a value of [(original image ID)−(paper ID)] before testing on the horizontal axis and plotting a value of [(residual image ID)−(paper ID)] after testing on the vertical axis was determined for each paper to be evaluated, and an arithmetic average thereof for several types of paper was adopted as a ratio of color fastness to rubbing. This numerical value represents the proportion of the density of the residual image to that of the original image, and it is indicated that as the numerical value is larger, the abrasion resistant performance is higher. For example, a ratio of color fastness to rubbing of 0.8 indicates that the density of a residual image which remains after an image having an image density of 1.5 is rubbed is 1.2. The ratio of color fastness to rubbing versus the proportion of the color developing agent is shown in Table 3.

In the case of this formulation using 1.5% secondary aminomorphol, the powder density was 0.83 and therefore, the color development was determined to be good. Further, the erasing ratio was 0.066, and therefore, the color erasure was determined to be good. The ratio of color fastness to rubbing was 0.90, and therefore the performance of color fastness to rubbing was determined to be good. Further, by a paper feed test in which 10000 sheets of paper were fed through MFP (e-studio 351) manufactured by Toshiba Tec Corporation, it was found that fixing can be performed without any problems.

### Example 8

### Preparation of Anthrarobin Derivative

### Preparation of Color Developing Agent (Nitration)

Methylene chloride: 60 g

Anthrarobin: 30 g

Concentrated nitric acid (concentration: 60%, density: 1.38 g/cm³): 10 g

After methylene chloride and anthrarobin were mixed in a three-neck flask, a thermometer, a cooling tube, and a dropping funnel were connected thereto. Then, the mixture was cooled to 0° C. while moderately stirring, and concentrated nitric acid was added dropwise thereto through the dropping funnel such that the temperature of the content was 5° C. or lower. After 30 minutes from the completion of the dropwise addition, an aqueous solution of sodium bicarbonate was slowly added thereto. After completion of neutralization, an oil layer was obtained with a separating funnel. While moderately stirring the oil layer, 1-hexane was added thereto to obtain a precipitate. The precipitate was sufficiently dried, whereby a nitrated intermediate was obtained. By performing GC-MS, H¹-NMR, and C¹³-NMR, it was found that a 98% nitrated anthrarobin compound was obtained.

### Preparation of Color Developing Agent (Hydrogenation)

DMF: 79 g

Nitrated anthrarobin: 20 g

5% Palladium catalyst: 1 g

DMF, the nitrated intermediate, and a magnetic stirrer were put in a 200 cc stainless steel autoclave, and further a 5% palladium catalyst was added thereto. Then, the mixture was moderately stirred and sufficiently subjected to nitrogen replacement, followed by hydrogen replacement, and then, 99.9% hydrogen was slowly filled into the autoclave to a pressure of 0.3 MPa. The mixture was heated to 80° C. in an oil bath, and pressurization was continued so as to maintain a constant pressure of 0.3 MPa. The pressurization was stopped when hydrogen was no longer consumed, and the resulting mixture was cooled to room temperature, and then sufficiently subjected to nitrogen replacement. Then, the content was taken out and distilled water was added thereto, whereby a precipitate was obtained. Then, the precipitate was sufficiently washed and dried. By performing GC-MS, H¹-NMR, and C¹³-NMR, it was found that a 98% primary aminoanthrarobin compound was obtained.

### Preparation of Color Developing Agent (Alkylation)

1-Butanol: 79 g

Primary aminoanthrarobin compound: 20 g

5% nickel mixed catalyst: 1 g

1-Butanol, the primary aminoanthrarobin compound, and a magnetic stirrer were put in a 200 cc stainless steel autoclave, and further a 5% nickel mixed catalyst was added thereto. Then, the mixture was moderately stirred and sufficiently subjected to nitrogen replacement. Subsequently, the mixture was heated to 120° C. in an oil bath and maintained for 5 hours. The resulting mixture was cooled to room temperature, and the content was taken out and distilled water was added thereto, whereby a precipitate was obtained. Then, the precipitate was sufficiently dried. By performing GC-MS, H¹-NMR, and C¹³-NMR, it was found that, as an anthrarobin derivative, a 98% secondary aminoanthrarobin compound was obtained.

The structure of the thus obtained secondary aminoanthrarobin compound is represented by the following formula (10).

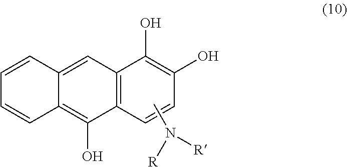

In the above formula (10), R represents hydrogen, alkyl, alkene, a benzene ring, a heterocyclic ring, cycloalkane, or cycloalkene; and R′ represents hydrogen, alkyl, alkene, a benzene ring, a heterocyclic ring, cycloalkane, or cycloalkene.

In this anthrarobin derivative, one amino group is located relative to two hydroxy groups at the ortho and meta positions.

### Preparation of Toner Particles

### Composition of Sample

CVL: 3.8 g

S205: 0.5 g

Polypropylene wax: 1.0 g

LR-147: 1.0 g

Secondary aminoanthrarobin: 1.5 g

Styrene-butadiene copolymer: 36.9 g

α-methylstyrene-styrene copolymer oligomer: 8.9 g

Polyester resin: 45.9 g

In the above sample, CVL (a leuco dye manufactured by Yamada Chemical Co., Ltd.) and 2-anilino-6-(N-ethyl-N-isopentylamino)-3-methylfluoran (a leuco dye S205, manufactured by Yamada Chemical Co., Ltd.) as color developable compounds, secondary aminoanthrarobin as a color developing agent, polypropylene wax as a wax component, a charge control agent (LR-147, manufactured by Japan Carlit Co., Ltd.), and a blend of a styrene-butadiene copolymer having a weight ratio of butadiene of 10 wt %, an α-methylstyrene-styrene copolymer oligomer, and a polyester resin (XPE 2007, manufactured by Mitsui Chemicals, Inc.) at a weight ratio of 4:1:5 as a binder resin were used.

The respective materials were sufficiently mixed using a Henschel mixer, and the resulting mixture was kneaded and dispersed using a triple roll (at a temperature of 140° C.). Further, the kneaded material was processed into fine powder having an average particle diameter of 6.8±0.5 μm using a crusher, whereby a blue electrophotographic toner was obtained. This fine powder was measured for powder density using a colorimeter CR-300 manufactured by Minolta Co., Ltd. (using a powder measurement cell). This powder density is a value calculated as a common logarithm of the reciprocal of the reflectivity. As the proportion of the color developable compound in a color developed state is higher, a higher powder density is obtained. The measurement results of the powder density are shown in FIG. 1 and Table 1.

Hydrophobic silica was externally added to the thus prepared toner in an amount of 1 wt % of the total amount of the toner. The resulting toner was used for printing a solid pattern with several stages of image ID on a sheet of copy paper using MFP (e-studio 351) manufactured by Toshiba Tec Corporation to prepare images for evaluating erasing performance. The image was erased by heating at 130° C. for 2 hours using a constant temperature chamber. The erasing performance was determined as follows. A slope of a regression line of data obtained by plotting a value of [(original image ID)−(paper ID)] before erasure by heating on the horizontal axis and plotting a value of [(residual image ID)−(paper ID)] after erasure by heating on the vertical axis was determined for each paper to be evaluated, and an arithmetic average thereof for several types of paper was adopted as an erasing ratio. This numerical value represents the proportion of the density of the residual image to that of the original image, and it is indicated that as the numerical value is smaller, the heat erasing performance is higher. For example, a heat erasing ratio of 0.05 indicates that the density of a residual image which remains after an image having an image density of 1.0 is erased by heating is 0.05. The erasing ratio versus the proportion of the color developing agent is shown in FIG. 2 and Table 2.

In addition, a patch pattern with several stages of image ID was printed on a sheet of copy paper and a color fastness to rubbing test was performed using a color fastness to rubbing tester RT-300 manufactured by Daiei Kagaku Seiki Mfg. Co., Ltd. The tester was set as follows: testing table shape: curved surface (radius: 200 mm), rubbing finger shape: curved surface (radius: 45 mm), testing load: 2 N, reciprocating rubbing distance: 120 mm, and reciprocating rubbing speed: 5 times. The performance of color fastness to rubbing was determined as follows. A slope of a regression line of data obtained by plotting a value of [(original image ID)−(paper ID)] before testing on the horizontal axis and plotting a value of [(residual image ID)−(paper ID)] after testing on the vertical axis was determined for each paper to be evaluated, and an arithmetic average thereof for several types of paper was adopted as a ratio of color fastness to rubbing. This numerical value represents the proportion of the density of the residual image to that of the original image, and it is indicated that as the numerical value is larger, the abrasion resistant performance is higher. For example, a ratio of color fastness to rubbing of 0.8 indicates that the density of a residual image which remains after an image having an image density of 1.5 is rubbed is 1.2. The ratio of color fastness to rubbing versus the proportion of the color developing agent is shown in Table 3.

In the case of this formulation using 1.5% secondary aminoanthrarobin, the powder density was 0.81 and therefore, the color development was determined to be good. Further, the erasing ratio was 0.079, and therefore, the color erasure was determined to be good.

The ratio of color fastness to rubbing was 0.91, and therefore the performance of color fastness to rubbing was determined to be good. Further, by a paper feed test in which 10000 sheets of paper were fed through MFP (e-studio 351) manufactured by Toshiba Tec Corporation, it was found that fixing can be performed without any problems.

### Comparative Example 3

Toner particles were prepared using 1.5% naphthol as a color developing agent.

### Preparation of Toner Particles

### Composition of Sample

CVL: 3.8 g

S205: 0.5 g

Polypropylene wax: 1.0 g

LR-147: 1.0 g

1-Naphthol: 5 g

Styrene-butadiene copolymer: 36.9 g

α-methylstyrene-styrene copolymer oligomer: 8.9 g

Polyester resin: 45.9 g

In the above sample, CVL (a leuco dye manufactured by Yamada Chemical Co., Ltd.) and 2-anilino-6-(N-ethyl-N-isopentylamino)-3-methylfluoran (a leuco dye S205, manufactured by Yamada Chemical Co., Ltd.) as color developable compounds, 1-naphthol as a color developing agent, polypropylene wax as a wax component, a charge control agent (LR-147, manufactured by Japan Carlit Co., Ltd.), and a blend of a styrene-butadiene copolymer having a weight ratio of butadiene of 10 wt %, an α-methylstyrene-styrene copolymer oligomer, and a polyester resin (XPE 2007, manufactured by Mitsui Chemicals, Inc.) at a weight ratio of 4:1:5 as a binder resin were used.

The respective materials were sufficiently mixed using a Henschel mixer, and the resulting mixture was kneaded and dispersed using a triple roll (at a temperature of 140° C.). Further, the kneaded material was processed into fine powder having an average particle diameter of 6.8±0.5 μm using a crusher, whereby toner particles were obtained. This fine powder was measured for powder density using a colorimeter CR-300 manufactured by Minolta Co., Ltd. (using a powder measurement cell). This powder density is a value calculated as a common logarithm of the reciprocal of the reflectivity. As the proportion of the color developable compound in a color developed state is higher, a higher powder density is obtained. The measurement results of the powder density are shown in FIG. 1 and Table 1.

In the case of this formulation using 1.5% naphthol, the ratio of color fastness to rubbing was 0.77, and therefore the performance of color fastness to rubbing was determined to be poor. Further, by a paper feed test in which 10000 sheets of paper were fed, a fixing belt got dirty, and therefore the fixing performance was determined to be poor due to offset. The powder density was 0.48 and therefore, the color development was determined to be poor. Further, the erasing ratio was 0.091, and therefore, the color erasure was determined to be poor.

### Comparative Example 4

Toner particles were prepared using 5% naphthol as a color developing agent.

### Preparation of Toner Particles

### Composition of Sample

CVL: 3.8 g

S205: 0.5 g

Polypropylene wax: 1.0 g

LR-147: 1.0 g

1-Naphthol: 5 g

Styrene-butadiene copolymer: 36.9 g

α-methylstyrene-styrene copolymer oligomer: 8.9 g

Polyester resin: 45.9 g

In the above sample, CVL (a leuco dye manufactured by Yamada Chemical Co., Ltd.) and 2-anilino-6-(N-ethyl-N-isopentylamino)-3-methylfluoran (a leuco dye S205, manufactured by Yamada Chemical Co., Ltd.) as color developable compounds, 1-naphthol as a color developing agent, polypropylene wax as a wax component, a charge control agent (LR-147, manufactured by Japan Carlit Co., Ltd.), and a blend of a styrene-butadiene copolymer having a weight ratio of butadiene of 10 wt %, an α-methylstyrene-styrene copolymer oligomer, and a polyester resin (XPE 2007, manufactured by Mitsui Chemicals, Inc.) at a weight ratio of 4:1:5 as a binder resin were used.

The respective materials were sufficiently mixed using a Henschel mixer, and the resulting mixture was kneaded and dispersed using a triple roll (at a temperature of 140° C.). Further, the kneaded material was processed into fine powder having an average particle diameter of 6.8±0.5 μm using a crusher, whereby a blue electrophotographic toner was obtained. Hydrophobic silica was externally added to the thus prepared toner in an amount of 1 wt % of the total amount of the toner. The resulting toner was used for printing a patch pattern with several stages of image ID on a sheet of copy paper using MFP (e-studio 351) manufactured by Toshiba Tec Corporation, and a color fastness to rubbing test was performed using a color fastness to rubbing tester RT-300 manufactured by Daiei Kagaku Seiki Mfg. Co., Ltd. The tester was set as follows: testing table shape: curved surface (radius: 200 mm), rubbing finger shape: curved surface (radius: 45 mm), testing load: 2 N, reciprocating rubbing distance: 120 mm, and reciprocating rubbing speed: 5 times. The performance of color fastness to rubbing was determined as follows. A slope of a regression line of data obtained by plotting a value of [(original image ID)−(paper ID)] before testing on the horizontal axis and plotting a value of [(residual image ID)-(paper ID)] after testing on the vertical axis was determined for each paper to be evaluated, and an arithmetic average thereof for several types of paper was adopted as a ratio of color fastness to rubbing. This numerical value represents the proportion of the density of the residual image to that of the original image, and it is indicated that as the numerical value is larger, the abrasion resistant performance is higher. For example, a ratio of color fastness to rubbing of 0.8 indicates that the density of a residual image which remains after an image having an image density of 1.5 is rubbed is 1.2.

In the case of this formulation using 5% 1-naphthol, the ratio of color fastness to rubbing was 0.32, and therefore the performance of color fastness to rubbing was determined to be poor. Further, by a paper feed test in which 10000 sheets of paper were fed, a fixing belt got significantly dirty, and therefore the fixing performance was determined to be poor due to offset.

The powder density was 0.43 and therefore, the color development was determined to be poor. Further, the erasing ratio was 0.281, and therefore, the color erasure was determined to be poor.

TABLE 1

| | | Proportion of color | | | | |
|---|---|---|---|---|---|---|
| | | developing agent (wt %) | | | | |
| | | 0.5 | 1 | 1.5 | 2 | 2.5 |
| Powder density | Example 1 | 0.65 | 0.77 | 0.81 | 0.83 | 0.83 |
| | Example 2 | 0.63 | 0.75 | 0.82 | 0.83 | 0.84 |
| | Example 3 | 0.64 | 0.77 | 0.8 | 0.82 | 0.82 |
| | Example 4 | 0.61 | 0.75 | 0.79 | 0.8 | 0.81 |
| | Example 5 | 0.56 | 0.7 | 0.81 | 0.8 | 0.81 |
| | Example 6 | 0.61 | 0.73 | 0.79 | 0.8 | 0.8 |
| | Example 7 | 0.62 | 0.74 | 0.83 | 083 | 0.82 |
| | Example 8 | 0.61 | 0.71 | 0.81 | 0.8 | 0.8 |
| | Comparative | 0.22 | 0.35 | 0.45 | 0.52 | 0.61 |
| | example 1 | | | | | |
| | Comparative | 0.19 | 0.33 | 0.38 | 0.38 | 0.39 |
| | example 2 | | | | | |
| | Comparative | 0.19 | 0.31 | 0.48 | 0.5 | 0.58 |
| | example 3 | | | | | |
| | Comparative | 0.31 | 0.32 | 0.35 | 0.38 | 0.39 |
| | example 4 | | | | | |

TABLE 2

| | | Proportion of color | | | | |
|---|---|---|---|---|---|---|
| | | developing agent (wt %) | | | | |
| | | 0.5 | 1 | 1.5 | 2 | 2.5 |
| Erasing ratio | Example 1 | 0.058 | 0.065 | 0.071 | 0.079 | 0.092 |
| | Example 2 | 0.055 | 0.06 | 0.067 | 0.077 | 0.094 |
| | Example 3 | 0.055 | 0.058 | 0.072 | 0.079 | 0.091 |
| | Example 4 | 0.05 | 0.055 | 0.071 | 0.079 | 0.093 |
| | Example 5 | 0.054 | 0.061 | 0.07 | 0.079 | 0.089 |
| | Example 6 | 0.056 | 0.062 | 0.069 | 0.078 | 0.09 |
| | Example 7 | 0.051 | 0.061 | 0.066 | 0.079 | 0.094 |
| | Example 8 | 0.052 | 0.059 | 0.068 | 0.079 | 0.098 |
| | Comparative | 0.042 | 0.072 | 0.096 | 0.108 | 0.142 |
| | example 1 | | | | | |
| | Comparative | 0.081 | 0.122 | 0.156 | 0.188 | 0.251 |
| | example 2 | | | | | |
| | Comparative | 0.039 | 0.069 | 0.091 | 0.121 | 0.168 |
| | example 3 | | | | | |
| | Comparative | 0.075 | 0.119 | 0.151 | 0.178 | 0.234 |
| | example 4 | | | | | |

TABLE 3

| | | |
|---|---|---|
| Ratio of color fastness to | Example 1 | 0.89 |
| rubbing | Example 2 | 0.92 |
| | Example 3 | 0.92 |
| | Example 4 | 0.89 |
| | Example 5 | 0.92 |
| | Example 6 | 0.89 |
| | Example 7 | 0.9 |
| | Example 8 | 0.91 |
| | Comparative example 1 | 0.88 |
| | Comparative example 2 | 0.39 |
| | Comparative example 3 | 0.77 |
| | Comparative example 4 | 0.32 |

Incidentally, in FIG. 1, the reference numerals 101, 102, 103, 104, 105, 107, 108, 111, 112, 113, and 114 denote Example 1, Example 2, Example 3, Example 4, Example 5, Example 7, Example 8, Comparative example 1, Comparative example 2, Comparative example 3, and Comparative example 4, respectively.

Further, in FIG. 2, the reference numerals 201, 202, 203, 204, 205, 206, 207, 208, 211, 212, 213, and 214 denote Example 1, Example 2, Example 3, Example 4, Example 5, Example 6, Example 7, Example 8, Comparative example 1, Comparative example 2, Comparative example 3, and Comparative example 4, respectively.

### Example 9

Toner particles were prepared using malachite green lactone (MGL) as a color developable compound.

### Preparation of Color Developing Agent (Nitration)

Methylene chloride: 60 g

Pyrogallol: 30 g

Concentrated nitric acid (concentration: 60%, density: 1.38 g/cm³): 10 g

After methylene chloride and pyrogallol were mixed in a three-neck flask, a thermometer, a cooling tube, and a dropping funnel were connected thereto. Then, the mixture was cooled to 0° C. while moderately stirring, and concentrated nitric acid was added dropwise thereto through the dropping funnel such that the temperature of the content was 5° C. or lower. After 30 minutes from the completion of the dropwise addition, an aqueous solution of sodium bicarbonate was slowly added thereto. After completion of neutralization, an oil layer was obtained with a separating funnel. While moderately stirring the oil layer, 1-hexane was added thereto to obtain a precipitate. The precipitate was sufficiently dried, whereby a nitrated intermediate was obtained. By performing GC-MS, H¹-NMR, and C¹³-NMR, it was found that a 98% nitrated pyrogallol compound was obtained.

### Preparation of Color Developing Agent (Hydrogenation)

DMF: 79 g

Nitrated pyrogallol compound: 20 g

5% Palladium catalyst: 1 g

DMF, the nitrated pyrogallol compound, and a magnetic stirrer were put in a 200 cc stainless steel autoclave, and further a 5% palladium catalyst was added thereto. Then, the mixture was moderately stirred and sufficiently subjected to nitrogen replacement, followed by hydrogen replacement, and then, 99.9% hydrogen was slowly filled into the autoclave to a pressure of 0.3 MPa. The mixture was heated to 80° C. in an oil bath, and pressurization was continued so as to maintain a constant pressure of 0.3 MPa. The pressurization was stopped when hydrogen was no longer consumed, and the resulting mixture was cooled to room temperature, and then sufficiently subjected to nitrogen replacement. Then, the content was taken out and distilled water was added thereto, whereby a precipitate was obtained. Then, the precipitate was sufficiently washed and dried. By performing GC-MS, H¹-NMR, and C¹³-NMR, it was found that a 98% primary aminopyrogallol compound was obtained.

### Preparation of Color Developing Agent (Alkylation)

Methanol: 79 g

Primary aminopyrogallol compound: 20 g

5% nickel-copper mixed catalyst: 1 g

Methanol, the primary aminopyrogallol compound, and a magnetic stirrer were put in a 200 cc stainless steel autoclave, and further a 5% nickel-copper catalyst was added thereto. Then, the mixture was moderately stirred and sufficiently subjected to nitrogen replacement. Subsequently, the mixture was heated to 120° C. in an oil bath and maintained for 5 hours. The resulting mixture was cooled to room temperature, and the content was taken out and distilled water was added thereto, whereby a precipitate was obtained. Then, the precipitate was sufficiently dried. By performing GC-MS, H¹-NMR, and C¹³-NMR, it was found that, as a pyrogallol derivative, a 98% secondary aminopyrogallol compound was obtained.

The thus obtained secondary aminopyrogallol compound is represented by the above formula (2).

### Preparation of Toner Particles

### Composition of Sample

MGL represented by the following formula (11): 3.4 g

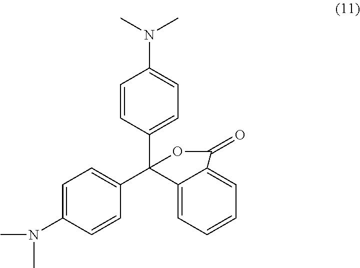

S205: 0.5 g

Polypropylene wax: 1.0 g

LR-147: 1.0 g

Secondary aminopyrogallol: 2 g

Styrene-butadiene copolymer: 37.1 g

α-methylstyrene-styrene copolymer oligomer: 8.9 g

Polyester resin: 46.1 g

In the above sample, MGL (a leuco dye manufactured by Yamada Chemical Co., Ltd.) and 2-anilino-6-(N-ethyl-N-isopentylamino)-3-methylfluoran (a leuco dye S205, manufactured by Yamada Chemical Co., Ltd.) as color developable compounds, secondary aminopyrogallol as a color developing agent, polypropylene wax as a wax component, a charge control agent (LR-147, manufactured by Japan Carlit Co., Ltd.), and a blend of a styrene-butadiene copolymer having a weight ratio of butadiene of 10 wt %, an α-methylstyrene-styrene copolymer oligomer, and a polyester resin (XPE 2007, manufactured by Mitsui Chemicals, Inc.) at a weight ratio of 4:1:5 as a binder resin were used.

The respective materials were sufficiently mixed using a Henschel mixer, and the resulting mixture was kneaded and dispersed using a triple roll (at a temperature of 140° C.). Further, the kneaded material was processed into fine powder having an average particle diameter of 6.8±0.5 μm using a crusher, whereby a blue electrophotographic toner was obtained. This fine powder was measured for powder density using a colorimeter CR-300 manufactured by Minolta Co., Ltd. (using a powder measurement cell). This powder density is a value calculated as a common logarithm of the reciprocal of the reflectivity. As the proportion of the color developable compound in a color developed state is higher, a higher powder density is obtained. The measurement results of the powder density are shown in FIG. 1.

Hydrophobic silica was externally added to the thus prepared toner in an amount of 1 wt % of the total amount of the toner. The resulting toner was used for printing a solid pattern with several stages of image ID on a sheet of copy paper using MFP (e-studio 351) manufactured by Toshiba Tec Corporation to prepare images for evaluating erasing performance. The image was erased by heating at 130° C. for 2 hours using a constant temperature chamber. The erasing performance was determined as follows. A slope of a regression line of data obtained by plotting a value of [(original image ID)−(paper ID)] before erasure by heating on the horizontal axis and plotting a value of [(residual image ID)−(paper ID)] after erasure by heating on the vertical axis was determined for each paper to be evaluated, and an arithmetic average thereof for several types of paper was adopted as an erasing ratio. This numerical value represents the proportion of the density of the residual image to that of the original image, and it is indicated that as the numerical value is smaller, the heat erasing performance is higher. For example, a heat erasing ratio of 0.05 indicates that the density of a residual image which remains after an image having an image density of 1.0 is erased by heating is 0.05. The erasing ratio versus the proportion of the color developing agent is shown in FIG. 2 and Table 2.

Further, a patch pattern with several stages of image ID was printed on a sheet of copy paper and a color fastness to rubbing test was performed using a color fastness to rubbing tester RT-300 manufactured by Daiei Kagaku Seiki Mfg. Co., Ltd. The tester was set as follows: testing table shape: curved surface (radius: 200 mm), rubbing finger shape: curved surface (radius: 45 mm), testing load: 2 N, reciprocating rubbing distance: 120 mm, and reciprocating rubbing speed: 5 times. The performance of color fastness to rubbing was determined as follows. A slope of a regression line of data obtained by plotting a value of [(original image ID)−(paper ID)] before testing on the horizontal axis and plotting a value of [(residual image ID)−(paper ID)] after testing on the vertical axis was determined for each paper to be evaluated, and an arithmetic average thereof for several types of paper was adopted as a ratio of color fastness to rubbing. This numerical value represents the proportion of the density of the residual image to that of the original image, and it is indicated that as the numerical value is larger, the abrasion resistant performance is higher. For example, a ratio of color fastness to rubbing of 0.8 indicates that the density of a residual image which remains after an image having an image density of 1.5 is rubbed is 1.2. The ratio of color fastness to rubbing versus the proportion of the color developing agent is shown in Table 3.

In the case of this formulation using MGL, the powder density was 0.81 and therefore, the color development was determined to be good. Further, the erasing ratio was 0.078, and therefore, the color erasure was determined to be good.

The ratio of color fastness to rubbing was 0.86, and therefore the performance of color fastness to rubbing was determined to be good. Further, by a paper feed test in which 10000 sheets of paper were fed through MFP (e-studio 351) manufactured by Toshiba Tec Corporation, it was found that fixing can be performed without any problems.

The following Table 4 shows the powder density, erasing ratio, and ratio of color fastness to rubbing when the proportion of the color developing agent was particularly 1.5 and 2.0 in Examples 1 to 9 and Comparative examples 1 to 4.

TABLE 4

| | | Proportion of color | | |
|---|---|---|---|---|
| | | developing agent | | |
| | | (wt %) | | |
| | | 1.5 | 2.0 | 5.0 |
| Example 1 | Powder density | 0.81 | 0.83 | — |
| | Erasing ratio | 0.071 | 0.079 | — |
| | Ratio of color fastness to rubbing | 0.89 | 0.89 | — |
| Example 2 | Powder density | 0.82 | 0.83 | — |
| | Erasing ratio | 0.067 | 0.077 | — |
| | Ratio of color fastness to rubbing | 0.9 | 0.92 | — |
| Example 3 | Powder density | 0.81 | 0.82 | — |
| | Erasing ratio | 0.076 | 0.079 | — |
| | Ratio of color fastness to rubbing | 0.91 | 0.92 | — |
| Example 4 | Powder density | 0.8 | 0.8 | — |
| | Erasing ratio | 0.078 | 0.079 | — |
| | Ratio of color fastness to rubbing | 0.88 | 0.89 | — |
| Example 5 | Powder density | 0.81 | 0.82 | — |
| | Erasing ratio | 0.07 | 0.071 | — |
| | Ratio of color fastness to rubbing | 0.92 | 0.93 | — |
| Example 6 | Powder density | 0.79 | 0.79 | — |
| | Erasing ratio | 0.069 | 0.07 | — |
| | Ratio of color fastness to rubbing | 0.89 | 0.91 | — |
| Example 7 | Powder density | 0.83 | 0.83 | — |
| | Erasing ratio | 0.066 | 0.069 | — |
| | Ratio of color fastness to rubbing | 0.9 | 0.9 | — |
| Example 8 | Powder density | 0.81 | 0.81 | — |
| | Erasing ratio | 0.079 | 0.08 | — |
| | Ratio of color fastness to rubbing | 0.91 | 0.93 | — |
| Example 9 | Powder density | 0.81 | 0.81 | — |
| | Erasing ratio | 0.077 | 0.078 | — |
| | Ratio of color fastness to rubbing | 0.89 | 0.89 | — |
| Comparative | Powder density | 0.45 | 0.52 | — |
| example 1 | Erasing ratio | 0.096 | 0.108 | — |
| | Ratio of color fastness to rubbing | 0.89 | 0.89 | — |
| Comparative | Powder density | — | — | 0.38 |
| example 2 | Erasing ratio | — | — | 0.267 |
| | Ratio of color fastness to rubbing | — | — | 0.39 |
| Comparative | Powder density | 0.48 | 0.51 | — |
| example 3 | Erasing ratio | 0.098 | 0.099 | — |
| | Ratio of color fastness to rubbing | 0.77 | 0.76 | — |
| Comparative | Powder density | — | — | 0.43 |
| example 4 | Erasing ratio | — | — | 0.281 |
| | Ratio of color fastness to rubbing | — | — | 0.32 |

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A color erasable coloring material, comprising a binder resin, a color developable compound and a color developing agent which are dispersed in the binder resin, the color developing agent containing an aminohydroxy derivative obtained by subjecting a starting material selected from a benzene ring compound having a hydroxy group and a heterocyclic compound having a hydroxy group to nitration, hydrogenation, and alkylation.

2. The material according to claim 1, wherein the aminohydroxy derivative is added in an amount of from 0.5 to 5 wt % of the total amount of the coloring material.

3. The material according to claim 1, wherein the aminohydroxy derivative is a benzene ring compound in which an amino group is located at the ortho position relative to the hydroxy group.

4. The material according to claim 1, wherein the aminohydroxy derivative is a benzene ring compound in which an amino group is located at the ortho and meta positions relative to the hydroxy group.

5. The material according to claim 1, wherein the aminohydroxy derivative is a benzene ring compound in which an amino group is located at the ortho and para positions relative to the hydroxy group.

6. The material according to claim 1, wherein the aminohydroxy derivative contains an amino group having a nitrogen atom and an alkyl group which is adjacent to the nitrogen atom and has 1 to 30 carbon atoms.

7. The material according to claim 1, wherein the benzene ring compound is selected from the group consisting of benzene, naphthalene, and anthracene.

8. The material according to claim 1, wherein the heterocyclic compound is selected from the group consisting of pyridine, pyrimidine, furan, and thiophene.

9. A method for producing a color erasable coloring material, comprising:
preparing an aminohydroxy derivative by subjecting a starting material selected from a benzene ring compound having a hydroxy group and a heterocyclic compound having a hydroxy group to nitration, hydrogenation, and alkylation; and
mixing a color developing agent containing, as at least a part thereof, the aminohydroxy derivative, a color developable compound, and a binder resin.

10. The method according to claim 9, wherein the aminohydroxy derivative is contained in an amount of from 0.5 to 5 wt % of the total amount of the coloring material.

11. The method according to claim 9, wherein the aminohydroxy derivative is a benzene ring compound in which an amino group is located at the ortho position relative to the hydroxy group.

12. The method according to claim 9, wherein the aminohydroxy derivative is a benzene ring compound in which an amino group is located at the ortho and meta positions relative to the hydroxy group.

13. The method according to claim 9, wherein the aminohydroxy derivative is a benzene ring compound in which an amino group is located at the ortho and para positions relative to the hydroxy group.

14. The method according to claim 9, wherein the aminohydroxy derivative contains an amino group having a nitrogen atom and an alkyl group which is adjacent to the nitrogen atom and has 1 to 30 carbon atoms.

15. The method according to claim 9, wherein the benzene ring compound is selected from the group consisting of benzene, naphthalene, and anthracene.

16. The method according to claim 9, wherein the heterocyclic compound is selected from the group consisting of pyridine, pyrimidine, furan, and thiophene.
